(19) United States
(12) Patent Application Publication
(10) Pub. No.: US 2026/0148950 A1
(43) Pub. Date: May 28, 2026

(54) METHODS AND SYSTEMS FOR PREDICTIVE ANALYSIS BY MASS SPECTROMETRY

(71) Applicant: Matterworks Inc, Somerville, MA (US)

(72) Inventors: Timothy KASSIS, Malden, MA (US); Gabriel ASHER, Hanover, NH (US); Mimoun Cadosch DELMAR, Somerville, MA (US); Jennifer CAMPBELL, Arlington, MA (US); John M. GEREMIA, Wayland, MA (US)

(21) Appl. No.: 19/452,108

(22) Filed: Jan. 16, 2026

Related U.S. Application Data
(63) Continuation of application No. PCT/US2024/038722, filed on Jul. 19, 2024.
(60) Provisional application No. 63/514,406, filed on Jul. 19, 2023.
(60) Provisional application No. 63/550,537, filed on Feb. 6, 2024.
(60) Provisional application No. 63/652,965, filed on May 29, 2024.

(51) Int. Cl. H01J 49/00; G01N 30/86; G06N 20/00

(52) U.S. Cl. CPC H01J 49/0036; G06N 20/00; G01N 30/8693

(57) ABSTRACT

Disclosed are methods and systems for predictive analysis by mass spectrometry

### CROSS-REFERENCE

This application is a continuation of International Patent Application No. PCT/US2024/038722, filed Jul. 19, 2024, which claims the benefit of U.S. Provisional Application No. 63/514,406, filed Jul. 19, 2023, U.S. Provisional Application No. 63/550,537, filed Feb. 6, 2024, and U.S. Provisional Application No. 63/652,965, filed May 29, 2024, each of which is incorporated herein by reference in its entirety.

### BACKGROUND

Mass spectrometry offer a powerful tool for analysis of biological and metabolomic samples due to its high sensitivity and specificity. Full utilization of the vast amount of data about a given sample provided by mass spectrometry, particularly where high-resolution mass spectrometers are paired with chromatography, is challenging due to the simultaneous high volume of information about an individual sample and the low volume of sample points available in biological systems which are often analyzed by mass spectrometry. Accordingly, methods of applying artificial intelligence to the problem of extracting insights from mass spectrometry data, including data obtained by—omic analysis of biological systems is needed both to improve a data utilization rate for information about a given sample, and to improve the level of insight that can be determined for biological systems with limited availability of sample points.

### SUMMARY

In one aspect, described herein are methods of analyzing a sample. In some embodiments, the method comprises introducing the sample to an inlet of a mass spectrometer. In some embodiments, the method comprises ionizing at least a portion of the sample. In some embodiments, the method comprises obtaining one or more raw mass spectra of the ionized portion of the sample using a mass spectrometer. In some embodiments, the method comprises processing the raw mass spectra of the ionized portion of the sample using a large spectral model having a data utilization rate of at least 2%, wherein m/z values of the one or more raw mass spectra are not binned during or prior to the processing, to generate at least one predictive classifier associated with the sample. In some embodiments, the method comprises outputting the at least one predictive classifier associated with the sample.

In some embodiments, the large spectral model is trained in a self-supervised manner. In some embodiments, wherein the large spectral model comprises a foundational spectral model and a fine-tuned predictive model. In some embodiments, the foundational spectral model is trained with data comprising data points which have not been explicitly labeled. In some embodiments, the foundation spectral model is trained with data which does not comprise explicitly labeled data points. In some embodiments, the training data comprise individual mass spectra without chromatographic information and/or comprise individual mass spectra with chromatographic information.

In some embodiments, the individual mass spectra comprise MS1 spectra, MS2 spectra, and/or combinations of thereof. In some embodiments, the individual mass spectra comprise high-resolution mass spectra. In some embodiments, the individual mass spectra are MS1 spectra.

In some embodiments, the large spectral model is configured to provide the at least one predictive classifier without a use of any MS2 data. In some embodiments, a fine-tune predictive model is configured to reduce a number of sample points required to train the large spectral model to generate the at least one predictive classifier. In some embodiments, a fine-tune predictive model is trained using data which is annotated or otherwise comprises meta-data associated with the at least one predictive classifier.

In some embodiments, a total number of sample points used as training data for the fine-tune predictive model is about 500 or less. In some embodiments, the total number of samples used as training data is about 200 or less. In some embodiments, the total number of samples used as training data is about 100 or less.

In some embodiments, wherein the number of sample points required to generate the at least one predictive classifier is reduced by about 10% or more (e.g., about 25% or more, about 50% or more, at least 75% or more, or at least 90% or more) compared to use of an otherwise identical large spectral model which does not comprise a fine-tune predictive model.

In some embodiments, the large spectral model comprises at least one transformer. In some embodiments, the at least one transformer comprises a transformer encoder block and a transformer decoder block. In some embodiments, the transformer encoder block comprises a plurality of encoder layers, and/or the transformer decoder block comprises a multi-layer perceptron (MLP). In some embodiments, the decoder block comprises an LDA model.

In some embodiments, the at least one predictive classifier associated with the sample comprises a predictive value selected from: an absolute quantitation of at least one target molecule, an identification of one or more molecules comprised within the sample, an identification of one or more biomarkers associated with a condition of a subject associated with the sample, an identification of a phenotype of a subject associated with the sample, and/or a combination of two or more thereof.

In some embodiments, the at least one target molecule is a metabolite or a plurality of metabolites. In some embodiments, the at least one target molecule is embedded in a sample matrix that is different from any matrices of sample points used for training the large spectral model. In some embodiments, the trained machine learning model is configured to interpolate across the plurality of different matrices to determine the at least one predictive classifier.

In some embodiments, the plurality of metabolites are selected from the group consisting of beta-nicotinamide adenine dinucleotide, glutamine, hypotaurine, n-methyl-alanine, citrate, threonine, purine, n-acetylneuraminate, n-acetylmannosamine, pyrimidine, trans-aconitate, urate, cytidine, serine, cysteine, citrulline, taurine, n-acetyltryptophan, nicotinate, inosine, gamma-aminobutyrate, cytosine, isoleucine, pyrazole, glutamate, ascorbate, p-hydroxyphenylacetate, n-acetylglucosamine, glycolate, sarcosine, creatinine, quinate, dihydroorotate, malonate, guanidinoacetate, formamide, glycine, methionine, tetrahydrofolate, 2-phosphoglycerate, methylthioadenosine, thymidine, cys-gly, aminoisobutanoate, gulose, xanthine, dihydrofolate, cystine, 1-alanine, diethanolamine, uridine monophosphate, proline, thymine, succinate semialdehyde, lactate, uridine, fructose bisphosphate, carnosine, nicotinamide, shikimate, succinate, phenylalanine, uracil, thiourea, aspartate, deoxycytidine monophosphate, hypoxanthine, creatine, 1-dopa, guanosine, dihydrouracil, malate, isocitrate, tyrosine, glycerol, asparagine, valine, guanine, homoserine, pyridoxine, deoxyadenosine monophosphate, folate, nicotinamide mononucleotide, 3-methyl-1-histidine, diaminopimelate, aminoadipate, deoxycytidine, noradrenaline, glucosamine 6-phosphate, tartrate, 3-dehydroshikimate, caffeine, homocysteine, theophylline, leucine, trehalose, betaine, tryptophan, 3-sulfinoalamine, o-succinyl-homoserine, allantoin, glyceraldehyde, d-glucuronolactone, (2-aminoethyl)phosphonate, 2,5-dihydrobenzoic acid, maleimide, threitol, glucosamine, paraxanthine, adenosine 5′-diphosphate, 2-deoxy-d-glucose, 1-methyl-1-histidine, galactitol, oxoproline, 4-pyridoxine, quinolinate, methylguanidine, deoxyguanosine-monophosphate, 3-hydroxy-3-methylglutaryl-coa, glucuronate, 1-methyladenosine, deoxyuridine, gluconate, urocanate, kynurenine, pyroglutamate, 4-acetamidobutanoate, trans-1,2-cyclohexanediol, melanin, dopamine, adenosine-monophosphate, lysine, citicoline, 1,3-diaminopropane, phosphoserine, 1-aminocyclopropanecarboxylate, glutarylcarnitine, cystathionine, norvaline, 3-hydroxymethylglutarate, phosphonoacetate, picolinate, ethanolamine, arginine, trans-4-hydroxy-1-proline, fucose, homocystine, n-methylglutamate, d-omithine, xanthosine, 3-methylcrotonyl-coa, thyrotropin releasing hormone, cysteate, n-methylaspartate, galactarate, alpha-hydroxyisobutyrate, nicotinic acid adenine dinucleotide phosphate, n-acetylasparagine, pipecolate, glucose 6-phosphate, nadp, 6-phosphogluconate, isopentenyl pyrophosphate, guanosine triphosphate, dtdp-d-glucose, agmatine sulfate, glycolaldehyde, dgtp, n-acetylglycine, n-acetylaspartate, inosine 5′-diphosphate, palmitoylcarnitine, norspermidine, nicotinamide hypoxanthine dinucleotide, s-adenosylmethionine, erythritol, glucosaminate, uridine triphosphate, 2-keto-3-deoxy-d-gluconic acid, d-sedoheptulose, 1,4-diaminobutane dihydrocloride, deoxycamitine, adenosine 2′,3′-cyclic phosphate, mevalolactone, galactose 1-phosphate, dimethylallylpyrophosphate, deoxyuridine triphosphate, phosphorylcholine, o-acetylcarnitine, 6-hydroxydopamine, thiamine, dgdp, 5-methylcytosine, glycerate, cytidine 2′,3′-cyclic phosphate, n,n,n-trimethyllysine, riboflavin, uridine diphosphate glucose, methyl galactoside, pyridoxal-phosphate, dihydroxyacetone phosphate, phosphoenolpyruvate, mannose 6-phosphate, 3-phosphoglycerate, 1-carnitine, o-phosphoethanolamine, o-acetylserine, cytidine monophosphate, guanosine diphosphate mannose, adp-glucose, fructose 6-phosphate, adenosine 3′,5′-diphosphate, 3-nitro-1-tyrosine, p-octopamine, n-alpha-acetyllysine, uridine diphosphategalactose, dihydroxyfumarate, pyridoxamine, 5-aminolevulinate, deoxyuridine-monophosphate, 5′-deoxyadenosine, ribose 1,5-bisphosphate, xanthosine-monophosphate, fad, deoxyguanosine, orotate, lauroylcarnitine, 1-methylnicotinamide, spermine, n-acetylmethionine, carbamoyl phosphate, phosphoribosyl pyrophosphate, aicar, uridine diphosphate-n-acetylgalactosamine, glyceraldehyde 3-phosphate, cyclic gmp, homocysteine thiolactone, o-phosphoserine, s-adenosylhomocysteine, 1-ornithine, adenine, normetanephrine, uridine diphosphate-n-acetylglucosamine, guanosine diphosphate, glutathione reduced, uridine diphosphate glucuronic acid, n,n-dimethylarginine, cytidine diphosphate, selenocystamine, histamine, indoxyl sulfate, ethyl 3-ureidopropionate, deoxyribose, phytate, thiamine monophosphate, uracil 5-carboxylate, s-hexyl-glutathione, glyoxylate, guanosine monophosphate, n-acetylalanine, 4-guanidinobutanoate, hydroxypyruvate, d-mannosamine, cytochrome c, deoxyadenosine, n-acetylputrescine, n-acetylgalactosamine, n-acetylglutamate, 2,4-dihydroxypteridine, 6-hydroxynicotinate, n-acetylcysteine, inosine-monophosphate, pantothenate, 2-aminoisobutyrate, aniline-2-sulfonate, s-carboxymethylcysteine, rhamnose, thiamine pyrophosphate, histidinol, thymidine-monophosphate, ureidopropionate, 5-aminopentanoate, norleucine, n-formylglycine, adenosine, raffinose, meso-tartrate, 2-acetamido-2-deoxy-beta-d-glucosylamine, saccharate, adenosine triphosphate, 3-methoxytyrosine, lactose, 3-hydroxybutanoate, 4-imidazoleacetate, galacturonate, cytidine triphosphate, cyclic amp, methionine sulfoximine, cis-4-hydroxy-d-proline, n1-acetylspermine, glucosamine 6-sulfate, nadph, 3-methylhistamine, maleamate, choline, methyl 4-aminobutyrate, n-formyl-1-methionine, acetylcholine, oxalate, 5-hydroxytryptophan, d-alanine, theobromine, guanidinosuccinate, histidine, allothreonine, phosphocreatine, spermidine, adenosine diphosphate ribose, 2-methoxyethanol, citramalate, anserine, biliverdin, 5-hydroxylysine, cysteamine, ophthalmate, mesoxalate, trigonelline, epinephrine, 3,4-dihydroxyphenylglycol, cadaverine, 2-hydroxybutyrate, coenzyme a, oxalomalate, inosine triphosphate, cdp-ethanolamine, 2,5-dimethylpyrazine, stachyose, deoxycytidine-diphosphate, 2,3-butanediol, d-ribose 5-phosphate, hydroxykynurenine, galactosamine, deoxyadenosine triphosphate, glycerol 3-phosphate, cyanocobalamin, 4-hydroxy-1-phenylglycine, n-acetylserine, uridine 5′-diphosphate, methyglutarate, sorbate, monoethylmalonate, gluconolactone, 4-hydroxybenzoate, tyramine, cortisol, prenol, 3-hydroxybenzaldehyde, xanthurenate, 2-methylpropanal, indoxyl B-glucoside, trimethylamine, melatonin, maleate, pentanoate, propanoate, bilirubin, nicotine, pregnenolone sulfate, kynurenate, isobutyrate, 3-hydroxybenzyl alcohol, aniline, acetoin, 3,5-diiodo-1-tyrosine, mandelate, tryptamine, 4-aminobenzoate, glutarate, 5-valerolactone, caffeate, lumichrome, beta-alanine, n-acetylphenylalanine, n-acetylproline, 1-tryptophanamide, phenol, n-methyltryptamine, oxaloacetate, 2,3-dihydroxybenzoate, 2-propenoate, indole-3-ethanol, ferulate, glycocholate, phenylethanolamine, thiopurine s-methylether, 2-hydroxy-4-(methylthio)butanoate, glycochenodeoxycholate, benzoate, 3-amino-5-hydroxybenzoate, pyrocatechol, 3,4-dihydroxybenzoate, cyclopentanone, pantolactone, guaiacol, 2-hydroxyphenylacetate, 10-hydroxydecanoate, didecanoyl-glycerophosphocholine, 2-hydroxypyridine, 3,4-dihydroxyphenylacetate, n6-(delta2-isopentenyl)-adenine, methyl vanillate, 2-oxobutanoate, lipoamide, 3-hydroxyanthranilate, 3-(4-hydroxyphenyl)pyruvate, hexanoate, methylmalonate, indole-3-acetate, cortisol 21-acetate, indole-3-acetamide, hippurate, ethylmalonate, 3,5-diiodo-1-thyronine, fumarate, benzaldehyde, 4-hydroxybenzaldehyde, 3-(2-hydroxyphenyl)propanoate, 3-methoxytyramine, benzylamine, 2-quinolinecarboxylate, serotonin, pterin, butanoate, 2-aminophenol, 6-carboxyhexanoate, indole-3-pyruvate, dehydroascorbate, 3-amino-4-hydroxybenzoate, 3,4 dihydroxymandelate, 2-methylcitrate, dihydrobiopterin, beta-glycerophosphate, glucose 1-phosphate, 2,3-diaminopropionate, 2,5-dihydroxybenzoate, 4-quinolinecarboxylate, hydroquinone, dethiobiotin, 3-hydroxybenzoate, 2-methylbutanal, n-acetylserotonin, hydrophenyllactic acid, itaconate, azelate, oxoadipate, 2-methylglutarate, phenylacetaldehyde, 3-methyl-2-oxovalerate, porphobilinogen, diacetyl, pyruvate, trans-cinnamaldehyde, 2,6-dihydroxypyridine, vanillin, methyl acetoacetate, suberate, adipate, geranyl-pp, n-acetylleucine, 2′, 4′-dihydroxyacetophenone, benzyl alcohol, monomethylglutarate, indole-3-methyl acetate, mevalonate, 3-methoxy-4-hydroxymandelate, homovanillate, 2-methylmaleate, 1-phenylethanol, salsolinol, salicylamide, oxoglutarate, ethyl 3-indoleacetate, 3-alpha,11-beta,17,21-tetrahydroxy-5-beta-pregnan-20-one, n,n-dimethyl-1,4-phenylenediamine, homogentisate, indoleacetaldehyde, 4-hydroxy-3-methoxyphenylglycol, 3-hydroxyphenylacetate, 4-methylcatechol, pyridoxal, salicylate, sebacate, 3-methyl 2-oxindole, 3-methyladenine, hydroxyphenyllactate, biotin, mercaptopyruvate, pyruvic aldehyde, pyrrole-2-carboxylate, 5-hydroxyindoleacetate, 3-methylglutaconate, resorcinol monoacetate, acetoacetate, acetylphosphate, sorbose, xylitol, ribitol, myoinositol, mannose, xylose, sucrose, galactose, alpha-d-glucose, allose, mannitol, melibiose, sorbitol, maltose, tagatose, 1-gulonolactone, arabinose, cellobiose, psicose, arabitol, lyxose, ribose, palatinose, d-pinitol, vitamin d2, squalene, 4-coumarate, nonanoate, estradiol-17alpha, caprylate, ursodeoxycholate, petroselinate, dipalmitoylglycerol, corticosterone, lithocholate, protoporphyrin, heptanoate, retinol, menaquinone, elaidate, chenodeoxycholate, myristate, cholesteryl oleate, rosmarinate, glyceryl tripalmitate, cortexolone, lithocholyltaurine, palmitoleate, palmitate, liothyronine, sphinganine, lanosterol, laurate, arachidate, erucate, deoxycholate, ketoleucine, eicosapentaenoate, heptadecanoate, glyceiyl trimyristate, linoleate, sphingomyelin, 7-dehydrocholesterol, thyroxine, bis(2-ethylhexyl)phthalate, gamma-linolenate, omega-hydroxydodecanoate, methyl jasmonate, dipalmitoyl-phosphatidylcholine, hexadecanol, 5,6-dimethylbenzimidazole, retinoate, indole, cholate, phylloquinone, cholesteiyl palmitate, quinoline, docosahexaenoate, diethyl 2-methyl-3-oxosuccinate, retinyl palmitate, 2-undecanone, 1-hydroxy-2-naphthoate, dipalmitoyl-phosphoethanolamine, phenylpyruvate, trans-cinnamate, oleate, stearate, beta-carotene, 25-hydroxycholesterol, nervonate, desmosterol, deoxycorticosterone acetate, oleoyl-glycerol, alpha-tocopherol, glycerol-myristate, tricosanoate, coenzyme q10, cortisone, and decanoate.

In some embodiments, the method comprises separating the sample using a chromatographic column prior to introduction into the mass spectrometer.

In some embodiments, the chromatographic column is a liquid chromatographic column or a gas chromatographic column.

In some embodiments, the sample is a fermentation broth, a cell culture medium, a tissue culture medium, urine, fecal matter, blood, blood plasma, mucus, saliva, soil, and/or combinations of two or more thereof.

In some embodiments, the large spectral model comprises one or more of a logistic regression, an ada boost classifier, an extra trees classifier, an extreme gradient boosting, a gaussian process classifier, a gradient boosting classifier, a K-nearest neighbor classifier, a light gradient boosting classifier, a linear discriminant analysis classifier, a multi-level perceptron, a naïve Bayes classifier, a quadratic discriminant analysis classifier, a random forest classifier, a ridge classifier, an SVM (linear and radial kernels), a fully-connected neural network, and/or a deep neural network.

In some embodiments, the at least one predictive classifier comprises one or more classifiers identifying and/or characterizing a metabolic pathway. In some embodiments, the at least one predictive classifier comprises one or more classifiers characterizing a cell response or a cell behavior for one or more cells. In some embodiments, the at least one predictive classifier comprises one or more classifiers identifying one or more options or solutions for optimizing a media provided to one or more cells to promote or facilitate cell culturing or cell growth in a biomanufacturing process. In some embodiments, the at least one predictive classifier comprises one or more classifiers characterizing a cell response or cell behavior to aid in a development of one or more cell lines.

In some embodiments, the method comprises using the at least one predictive classifier to aid in a development of one or more processes for cell line manufacturing. In some embodiments, the method comprises using the at least one predictive classifier to aid in an analysis and/or comparison of clonal variations of one or more cells and/or metabolic states or pathways associated with the clonal variations. In some embodiments, the method comprises using the at least one predictive classifier to aid in a detection of one or more metabolic signatures or pathways for the one or more cells.

In some embodiments, the large spectral model is trained for at least one epoch (e.g., at least 1, 2, 3, 4, 5, 10, 20 or 30 epochs). In some embodiments, the large spectral model is trained for at least 50 epochs (e.g. at least 50, 100, or 200 epochs). In some embodiments, the at least one predictive classifier associated with the sample comprises a predicted intensity and/or a predicted m/z value of at least one ion of the ionized portion of the sample. In some embodiments, a plurality of predictive classifiers associated with the sample are used to predict a mass spectrum of the sample. In some embodiments, the number of epochs is chosen based on the size of the training data set. In some embodiments, the number of epochs is chosen to avoid or reduce over-fitting of the training data.

In some embodiments, the large spectral model produces an R2 of predicted intensity values of at least 0.3, the large spectral model produces an R2 of predicted m/z values of at least 0.9, the large spectral model produces a mean absolute error of predicted intensity values of no more than 5%, the large spectral model produces a mean absolute error of predicted m/z values of no more than 2, the large spectral model produces a symmetric mean absolute percentage error of predicted intensity values of no more than 10%, the large spectral model produces a symmetric mean absolute percentage error of predicted m/z values of no more than 10%, the large spectral model produces a weighted loss of predicted intensity values of no more than 5%, the large spectral model produces weighted loss of predicted m/z values of no more than 5%, and/or combinations of two or more thereof. In some embodiments, an area under-the-curve (AUC) value of a computed receiver operator curve (ROC) of the large spectral model is at least 0.9 (e.g. at least 0.9, at least 0.95, or at least 0.99).

In some embodiments, a resolution of the mass spectrometer and/or the mass spectra is at least 30,000. In some embodiments, the one or more raw mass spectra and/or mass spectra comprised in data used to train the large spectral model comprise a mass range of about 50-20,000 m/z. In some embodiments, the one or more raw mass spectra and/or mass spectra comprised in data used to train the large spectral model comprise a mass range of about 50-5,000 m/z.

The method of any one of the preceding claims, wherein the one or more raw mass spectra and/or mass spectra comprised in data used to train the large spectral model comprise a mass range of about 50-2,000 m/z.

In some embodiments, methods described herein can comprise providing a media to one or more cells. In some embodiments, the methods comprise analyzing one or more biological samples comprising (i) the one or more cells and/or (ii) outputs of the one or more cells after the one or more cells process the media to generate at least one predictive classifier associated with the analyzed one or more biological samples by the method of any one of the preceding claims.

In some embodiments, the methods comprise optimizing the media based on the at least one predictive classifier.

In some embodiments, the at least one predictive classifier comprises a classifier of one or more physical or chemical properties of one or more unknown molecules comprised in the sample. In some embodiments, the at least one predictive classifier comprises a plurality of classifiers of at least 5 (e.g. at least 10, 20, 50, or 100) physical and/or chemical properties of one or more unknown molecules comprised in the sample. In some embodiments, the at least one predictive classifier comprises a classifier of one or more physical or chemical properties of each of a plurality of unknown molecules comprised in the sample.

In some embodiments, the sample comprises at least 3 (e.g. at least 5, 10, 50, 100, or 200) unknown molecules. In some embodiments, the physical or chemical properties comprise a molecular identity of—, and/or an identification of one or more functional groups comprised in—, the one or more unknown molecules.

In some embodiments, the data utilization rate of methods described herein is at least 10% (e.g. at least 10%, at least 50%, at least 70%, at least 90% or at least 95%).

In some embodiments, the sample is a biological sample.

In another aspect, described herein are non-transitory computer-readable storage media comprising a set of instructions for executing the any of the methods described herein.

In a further aspect, described herein are systems comprising a computing unit. In some embodiments, the systems further comprise a mass spectrometer, operably coupled to the computing unit.

In some embodiments, the computing unit comprises an analysis module configured to, in combination with a mass spectrometer, perform any of the methods described herein.

Another aspect of the present disclosure provides a non-transitory computer readable medium comprising machine executable code that, upon execution by one or more computer processors, implements any of the methods above or elsewhere herein.

Another aspect of the present disclosure provides a system comprising one or more computer processors and computer memory coupled thereto. The computer memory comprises machine executable code that, upon execution by the one or more computer processors, implements any of the methods above or elsewhere herein.

Additional aspects and advantages of the present disclosure will become readily apparent to those skilled in this art from the following detailed description, wherein illustrative embodiments of the present disclosure are shown and described. As will be realized, the present disclosure is capable of other and different embodiments, and its several details are capable of modifications in various obvious respects, without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 schematically illustrates a signal processing module in accordance with embodiments described herein.

FIG. 2 schematically illustrates a deep neural network for signal processing in accordance with embodiments described herein.

FIG. 3 schematically illustrates individual sub-models that can be trained in accordance with embodiments described herein.

FIG. 4 schematically illustrates a computer system that is programmed or otherwise configured to implement methods provided herein.

FIG. 5 illustrates an example of a Large Spectra Model (LSM) in accordance with embodiments described herein.

FIG. 6 illustrates a Receiver Operator Curve (ROC) for Predictive Modeling of a clinical dataset using a large spectral model in accordance with embodiments described herein.

FIGS. 7A-7B illustrate fine-tuning of a Large Spectra Model (LSM) for predictive biomarker discovery in accordance with embodiments described herein. FIG. 7A illustrates example generation of subject-labeled data. FIG. 7B illustrates am example of a fine-tuned global predictive classifier comparing with conventional biomarker analysis in accordance with embodiments described herein.

FIG. 8 illustrates an example GUI of plasma metabolome vector search module in accordance with embodiments described herein.

FIG. 9A illustrates an example embedding method useful in certain embodiments described herein. A learnable lookup table was used on the intensity value and separate integer and decimal parts of each peak's m/z in the example implementation. These embeddings are concatenated and passed through a linear layer to generate a peak token. All peak tokens in a spectrum form a sequence of tokens, that are then input to the transformer.

FIG. 9B illustrates an example pre-training architecture useful in certain embodiments described herein. In the example, sequences with randomly masked peaks are fed into a series of transformer layers. The transformer output is then fed to separate m/z integer, m/z decimal, and intensity heads to reconstruct the masked tokens.

FIG. 10 illustrates model fine-tuning an example implementation utilizing the embedding and pre-training architectures described in FIGS. 9A-9B.

FIG. 11A illustrates an example model architecture for a fine-tuning task (illustrated here using property prediction as an example task). For property prediction, LSM outputs are fed into a prediction head to generate 209 molecular property descriptors, which are subsequently compared to ground truths calculated from SMILES.

FIG. 11B illustrates an example model architecture for a fine-tuning task (illustrated here using spectral lookup as an example task). For Spectral lookup, paired spectra are each fed through the LSM, then a projection head to generate a smaller molecular embedding. The model is trained to make the cosine similarity match the Tanimoto similarity of their respective smiles.

FIG. 12 illustrates symmetric mean absolute percentage error (SMAPE) performance on property categories (in %) for an example implementation of a large structural model which was fine-tuned for various molecular properties according to embodiments described herein.

FIG. 13 illustrates an example of property fine-tuning performance versus dataset size on unknown dataset according to embodiments described herein. Horizontal lines indicate performance of cosine similarity, supervised-only LSM, and ms2prop reimplementation.

FIG. 14 illustrates property performance for fixed embeddings versus dataset size on unknown dataset with fixed embeddings according to embodiments described herein. Horizontal lines indicate performance of cosine similarity, supervised-only LSM, and ms2prop re-implementation.

FIG. 15 illustrates symmetric mean absolute percentage error (SMAPE) performance on various property categories for various embodiments of a large structural model as described herein.

FIG. 16 illustrates R² on various property categories for various embodiments of a large structural model as described herein.

FIG. 17 illustrates mean absolute error (MAE) performance on various property categories for various embodiments of a large structural model as described herein.

FIG. 18 illustrates symmetric mean absolute percentage error (SMAPE) performance on various MS² property categories (i.e. properties of tandem, MS/MS mass spectra) for various embodiments of a large structural model as described herein.

FIG. 19 illustrates R² performance on various MS² property categories for various embodiments of a large structural model as described herein.

FIG. 20 illustrates mean absolute error (MAE) performance on various MS² property categories for various embodiments of a large structural model as described herein.

FIG. 21 illustrates fine-tuning performance versus dataset size on known dataset for an example large structural model according to embodiments described herein. Horizontal lines indicate performance of cosine similarity, supervised-only LSM, and ms2prop reimplementation.

FIG. 22 fine-tuning performance versus dataset size on a Critical Assessment of Small Molecule Identification (CASMI) dataset for an example large structural model according to embodiments described herein. Horizontal lines indicate performance of cosine similarity, supervised-only LSM, and ms2prop reimplementation.

FIG. 23 illustrates property fixed embedding performance versus dataset size on known dataset for an example large structural model according to embodiments described herein. Horizontal lines indicate performance of cosine similarity, supervised-only LSM, and ms2prop reimplementation.

FIG. 24 illustrates property fixed embedding performance versus dataset size on a CASMI dataset for an example large structural model according to embodiments described herein. Horizontal lines indicate performance of cosine similarity, supervised-only LSM, and ms2prop reimplementation.

FIG. 25 illustrates fixed embedding symmetric mean absolute percentage error (SMAPE) performance on property categories (fixed embedding model trained with 1, 10, and 100% of data) for an example large structural model according to embodiments described herein.

FIG. 26 illustrates fixed embedding R² Performance on property categories (fixed embedding model trained with 1, 10, and 100% of data) for an example large structural model according to embodiments described herein.

FIG. 27 illustrates fixed embedding SMAPE Performance on MS2Prop key properties (fixed embedding model trained with 1, 10, and 100% of data) for an example large structural model according to embodiments described herein.

FIG. 28 illustrates fixed embedding R² Performance on MS2Prop key properties (fixed embedding model trained with 1, 10, and 100% of data) for an example large structural model according to embodiments described herein.

FIG. 29 illustrates a plot of the distribution of both labeled and unlabeled data for an example large structural model according to embodiments described herein. The dotted vertical line is at number of peaks=64, which was the cutoff used for sequence length. The maximum bin in this example illustration was forced to be 256 for figure clarity.

FIG. 30 illustrates a plot of cumulative distribution functions (CDFs) of both labeled and unlabeled data for an example large structural model according to embodiments described herein. The dotted vertical line is at number of peaks=64, which was the cutoff used for sequence length. The maximum bin in this example illustration was forced to be 256 for figure clarity.

FIG. 31 illustrates example training workflows for large structural models described herein.

FIG. 32A illustrates an example of model architecture, training processes, and results for de novo molecular generation according to embodiments described herein utilizing a Self-Referencing Embedded Strings (SELFIES) autoloader.

FIG. 32B illustrates an example of model architecture, training processes, and results for de novo molecular generation according to embodiments described herein utilizing a conditional generative encoder.

FIG. 32C illustrates an example of model architecture, training processes, and results for de novo molecular generation according to embodiments described herein comprising large structural model (LSM) integration and fine-tuning.

FIG. 33 illustrates an example of consensus scoring assessment of functional motifs present in generative molecular structures according to embodiments described herein.

FIG. 34A illustrates a further example of a pre-training workflow according to embodiments described herein.

FIG. 34B illustrates a further example of a fine-tuning workflow according to embodiments described herein.

### DETAILED DESCRIPTION

“—omic” data may comprise metabolomic, proteomic, transcriptomic, and genomic data obtained from techniques such as mass spectrometry and whole genome sequencing. One aspect of extracting biological insight from data involves predictive modeling: constructing a pre-trained model and using model inferences to predict the state of one or more phenotypes, properties, behaviors, or other outcomes associated with a biological system.

Described herein are methods of applying such artificial intelligence methods, such as large spectral models to raw biological data, particularly for—omic data, such as raw mass spectral data or raw genomic data Predictive modeling efforts based on—omic data obtained in life sciences applications suffer from two significant challenges which are solved by methods and systems described herein. First, training data sets are typically small when compared to training data sets employed in other machine learning disciplines. This is because data annotation is dictated by the scale of biological experiments, such as clinical studies, pre-clinical studies, bioprocess development campaigns, etc. Common data sets in biology comprise a few hundred, a few thousand, or perhaps tens of thousands of samples, versus the millions or tens of millions of samples common in other machine learning applications.

Predictive modeling in biology has struggled to apply artificial intelligence to raw biological data. Due the high complexity of raw—omic data, human interpretation is generally first employed to extract recognized features from the raw data. Examples of recognized features include peaks in an LC/MS chromatogram, contigs and gene tokens in sequencing data, biomolecules listed in metabolomic catalogs, genes listed in gene catalogs, etc. Models are then constructed based on the characterization of only the pre-identified extracted features, regardless of whether these features were analyzed manually or algorithmically. The fundamental modeling workflow involves the steps of measuring raw data, featurizing the data (e.g., peak identification and characterization), and constructing stand-alone models that aim to associate biological properties (model outputs) with the extracted features (model inputs).

For example, in an LC/MS data set obtained in high-resolution accurate mass (HRAM) LC/MS, it is common for the instrument to detect tens of millions of parent-ion and fragment-ion intensities during the acquisition process. Yet, typical metabolomic annotation might exact only several hundred to several thousand annotated metabolites and pathways. Previously, it has been unknown how to take advantage of the vast quantity of detected data that goes overlooked through the process of feature extraction. Described herein are large spectral models and methods of implementing and using large spectral models to directly generate one or more predictive classifiers associated with a sample from raw mass spectrometry data.

Deep Learning (DL) strategies promise better predictive models for life sciences problems by exploiting the highly unstructured information content of biological and chemical data. Due to their complexity, and despite routine collection, it is hypothesized that the majority of the unstructured information content present in chemical and biological data, e.g., mass spectrometry data, is left unexploited by most predictive modeling and insight generation efforts.

Immediate challenges are faced when adapting DL methodologies from Natural Language Processing (NLP) and Computer Vision (CV) to the life sciences. The structure and abundance of genes, transcripts, proteins, and biomolecules (c.f., metabolites, lipids, drugs, drug metabolites, toxins, bioactives, etc.) are often continuous-valued, sparsely non-zero, and span orders of magnitude in dynamic range, and consequently, the associated primary instrument data involve multiple distinct normalization conventions even within a single data set. A more fundamental challenge facing DL efforts in the life sciences is that many methods pioneered for NLP and CV problems were borne of environments with abundant labeled data (e.g., text and image data obtained from the web, by mining corporate documents, etc.). Many of the AI advances generating current excitement in text and image processing have been trained on- and require-millions, tens of millions, or hundreds of millions of labeled data for supervised training of transformer models to converge without over-fitting.

In the life sciences, it is rare to come across high-quality labeled data sets of comparable size. In this context, labeled data means that the data are annotated with all relevant chemical, biological, pharmacological, clinical, etc., metadata Pre-clinical data sets in drug discovery might comprise a few thousand or a few ten-thousand labeled points, whereas clinical data sets may only house a few hundred or a few thousand. Even where large data archives have been curated, such as gene and metabolite databases, annotation is often sparse. For example, less than 2% of compounds detected in typical high-resolution liquid chromatographic mass spectrometric (LC/MS) and tandem mass spectrometric (LC/MS/MS) metabolomics experiments are readily annotated using available databases [da Silva et al., 2015]. One reason for the lack of annotation is the lack of precursor specificity in the collected data Precursors and fragments are detected with single part per million accuracy and separated with 10000 ppm mass accuracy. Unintended leakage of fragment from poorly selected precursors creates a large challenge in both the curation of MS/MS spectra and the use of databases to ID MS/MS spectra.

Thus, for the life sciences to capitalize on advanced DL, there is a fundamental need to reconcile the healthy data appetites of transformer-based architectures with the practical size limitations of real-world data sets. Self-supervised pre-training of large semantic foundation models using unlabeled data for mass spectrometry data are described herein. While labeled biological data sets are typically small, the aggregation of these data across many applications and experiments is large. For instance, through a combination of internally generated and externally sourced data acquisitions, more than 100 million unlabeled MS and MS/MS spectra have been accumulated, cumulative over a wide variety of underlying applications. These data are abundant, but unlabeled.

It is shown herein that pre-training on these (or subsets thereof) unlabeled data sets yields an advantage for predictive modeling when focused on a specific task and a relatively small volume of task-specific labeled data. Here, evidence is provided that self-supervised pre-training of a large semantic model (a.k.a., a foundation model) followed by fine-tuning a task-specific model using only a relatively small labeled data works potentially yields superior predictive power even versus a standalone DL model trained on a vastly labeled data set.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

The term “real time” or “real-time,” as used interchangeably herein, generally refers to an event (e.g., an operation, a process, a method, a technique, a computation, a calculation, an analysis, a visualization, an optimization, etc.) that is performed using recently obtained (e.g., collected or received) data. In some cases, a real time event may be performed almost immediately or within a short enough time span, such as within at least 0.0001 millisecond (ms), 0.0005 ms, 0.001 ms, 0.005 ms, 0.01 ms, 0.05 ms, 0.1 ms, 0.5 ms, 1 ms, 5 ms, 0.01 seconds, 0.05 seconds, 0.1 seconds, 0.5 seconds, 1 second, or more. In some cases, a real time event may be performed almost immediately or within a short enough time span, such as within at most 1 second, 0.5 seconds, 0.1 seconds, 0.05 seconds, 0.01 seconds, 5 ms, 1 ms, 0.5 ms, 0.1 ms, 0.05 ms, 0.01 ms, 0.005 ms, 0.001 ms, 0.0005 ms, 0.0001 ms, or less.

The term “data utilization rate” generally refer to a ratio of data produced by an analytical instrument which is considered by an operator or a machine learning algorithm when extrapolating predictions or drawing conclusions compared to the data produced which is not considered. For example, in mass spectrometry, data utilization for conventional analysis methodologies is often substantially less than 1% due to use of preprocessing steps such as filtering, peak fitting, averaging, and/or extraction of data for specific ions, while ignoring data collected for others.

Provided herein are methods for determining one or more predictive classifiers associated with an analyzed sample. In some cases, the methods provide near instantaneous determination of the absolute concentration of critical intra and extra cellular metabolites in bioprocessing. In some cases, the concentration of a target analyte is determined via liquid chromatography (LC), mass spectrometry (MS), or a combination thereof (LC/MS). In some cases, the methods utilize a deep learning model, one or more calibrators, and a platform to record expansive training data sets with high analytical fidelity. In some cases, machine learning models described herein can determine absolute quantities of target molecules without the direct use of any internal or external standard. In some cases, the methods provide the power to bypass the efforts (and expertise) of traditional techniques and go directly from raw mass spectrometry data to a scientific prediction or conclusion. In some instances, the method comprises little to no development time. In some instances, the method requires little to no expertise.

A first step in determining the abundance of a single analyte (e.g., mass-to-charge ratio (m/z)) from mass spectra data comprises extracting an intensity of a single m/z (e.g., exact m/z to +/−5 ppm) over the course of the LC run. The results curve is termed an extracted ion chromatogram (XIC) and the area under the curve (AUC) can be used as the signal in any computation of analyte concentration. AUC generally defines the necessary quality attributes of LC-MS data since there must be a well-defined curve to calculate area. Isomers may be well separated from each other, and each curve can contain a minimum of about 20 unique spectra (points across curve). The XIC is generally well defined enough to have a simply calculated area.

Absolute quantification can use extensive method development to link the AUC from the sample to an AUC from a standard in order to determine an accurate concentration (in moles/L or moles/cell count) of an identified analyte. In some cases, the advantage of absolute quantification is that it provides with an exact number that can be verified in an independent system. In some cases, the disadvantages are that substantial method development is required prior to samples being ready to quantify and only changes in identified analytes with a standard available can be determined. In some cases, in order to get from AUC to concentration, there is a need to create matched conditions using either matched isotopologues and/or calibration curves.

The systems and methods provided herein may not involve XIC or AUCs. Rather, the systems and methods provided herein can use a fundamentally different input. The systems and methods provided herein can enable a user to bypass method development and data analysis and get directly from a raw MS signal to an actionable predictive classifier associated with a sample of interest for a given application.

A sample 101 may further comprise one or more backgrounds or matrices. In some cases, the one or more matrices comprises a fermentation broth, a cell culture medium, a tissue culture medium, urine, fecal matter, blood, blood plasma, mucus, saliva, soil, or any combination thereof. In some cases, the one or more matrices is selected from the group consisting of a fermentation broth, a cell culture medium, a tissue culture medium, urine, fecal matter, blood, blood plasma, mucus, saliva, soil, or any combination thereof. In some cases, the one or more matrices comprises one or more salts. In some instances, the one or more salts comprise sodium ions, potassium ions, calcium ions, magnesium ions, ammonium cations, or any combination thereof. In some cases, the one or more salts comprise chloride, nitrate, sulfate, phosphate, formate, acetate, citrate anions, or any combination thereof. In some instances, the salt is sodium chloride. In some cases, the one or more matrices comprise one or more acids or bases. In some instances, the one or more matrices comprises hydrochloric acid, sulfuric acid, phosphoric acid, sodium hydroxide, potassium hydroxide, ammonium hydroxide, acetic acid, or any combination thereof. In some cases, the one or more matrices comprise a buffer. In some cases, the matrix comprises a citrate, phosphate, acetate buffer, or any combination thereof.

A sample 101 may be produced by a microbial community, such as a microbiome. In some cases, the microbiome samples are obtained from a human, an animal, a plant, a seed, a soil, an environment, or any combination thereof. In some instances, the microbiome sample is a sample of a gastrointestinal tract (e.g., stomach), skin, mammary glands, placenta, seminal fluid, uterus, ovarian follicles, lung, saliva, oral mucosa, conjunctiva, biliary tract, or any combination thereof. Methods of obtaining microbiome samples may be standard and/or known method to the skilled artisan.

The output signal from the MS machine 103 can comprise an intensity value, a mass-to-charge ratio, or a combination thereof. In some cases, the output signal from the MS comprises raw, unprocessed MS data. In some cases, the output signal comprises a first signal indicating an intensity value or a mass-to-charge ratio of one or more analytes. In some cases, the output signal comprises a second signal indicating an intensity value or a mass-to-charge ratio of one or more calibrators. In some cases, the output signal comprises the first signal and the second signal. In some instances, the output signal comprises the peak signal intensity obtained for an exact isotopic mass for each of the one or more analytes or one or more calibrators of known molecular weight. In some instances, the output signal comprises combined signals corresponding to one or more mass adducts for the one or more analytes. In some examples, the output signal for the one or more analytes is obtained by calculating the sum of the adduct signals for 1, 2, 3, 4, 5, 6, 7, 8, 9 or 10 analyte adducts. In some cases, the analyte adducts correspond to the proton, sodium, potassium, calcium, magnesium, ammonium, nitrate, sulfate, phosphate, acetate, citrate, or formate adducts. In one embodiment, the molecular weight of the adduct is calculated by subtracting or adding the mass of a proton and adding the mass of the corresponding adduct species.

The output signal from the MS machine 103 (e.g., mass spectrum, intensity value, mass-to-charge ratio, etc.) may be processed by a signal processing module 104. The input to the signal processing module 104 can comprise an input signal comprising an intensity value, a mass-to-charge ratio, or a combination thereof from the MS machine 103. In some cases, the input signal comprises a first signal indicating an intensity value or a mass-to-charge ratio of one or more analytes. In some cases, the input signal comprises a second signal indicating an intensity value or a mass-to-charge ratio of one or more calibrators. In some cases, the input signal comprises the first signal and the second signal from the MS machine 103. In some cases, the one or more calibrators produce a signal that does not overlap with a signal of the one or more analytes.

In some cases, the input to the signal processing module 104 comprises raw or unprocessed MS data. In some cases, the input comprises preprocessed MS data. Preprocessing MS data may comprise data cleaning, data transformation, data reduction, or any combination thereof. In some cases, data cleaning comprises cleaning missing data (e.g., fill in or ignore missing values), noisy data (e.g., binning, regression, clustering, etc.), or a combination thereof. In some cases, data transformation comprises standardization, normalization, attribute selection, discretization, hierarchy generation, or any combination thereof. In some cases, data reduction comprises data aggregation, attribute subset selection, numerosity reduction, dimensionality reduction, or any combination thereof. In some cases, the MS data is preprocessed prior to the signal processing module 104. In some cases, the MS data is preprocessed in the signal processing module 104. In some cases, m/z values are not binned at any point during the pre-processing.

In some cases, the signal processing module 104 comprises a machine learning model. In some instances, the machine learning model is a trained machine learning model. In some instances, the trained machine learning model determines an absolute concentration 105 of the one or more analytes based on the output signal from the MS machine 103. In some cases, the trained machine learning model is configured to determine the absolute concentration 105 of the one or more analytes based on a relationship or a correlation between the first signal and a known concentration of the one or more calibrators. In some instances, the trained machine learning model is configured to determine the absolute concentration 105 based on a relationship or a correlation between the first signal and the second signal. In some instances, the absolute concentration 105 of the one or more analytes is determined based on the known concentration of the one or more calibrators. In some examples, the absolute concentration comprises a molar concentration or a mass concentration. In some examples, the absolute concentration is determined based at least in part on a relationship or correlation between the MS signal of the one or more calibrators and the MS signal of the one or more analytes.

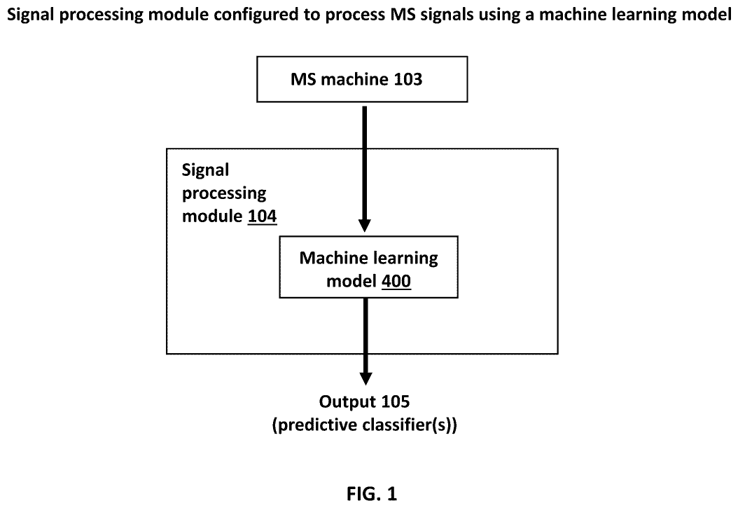

Referring to FIG. 1, the one or more predictive classifiers can be determined by generating a MS output for the sample mixture from a MS machine 103. In some cases, the MS output comprises an MS signal of one or more samples. The MS signal can comprise raw, unprocessed data or processed data, as described herein. The MS signal can comprise a mass spectrum, an intensity value, a mass-to-charge ratio, or any combination thereof, as described herein.

The MS output can be processed by the signal processing module 104. The signal processing module 104 can comprise a machine learning model 400. The machine learning model may be a trained machine learning algorithm. The trained machine learning model may be used to determine one or more predictive classifiers associated with one or more samples 105.

The machine learning model may learn based on one or more features. In some cases, the number of features in a machine learning model is optimized. The machine learning model can be trained on MS data. In some cases, the machine learning model is trained with one or more reference samples.

In some cases, the one or more features of the machine learning model corresponds to signals obtained for a plurality of reference samples using a plurality of instrument acquisition parameters. In some cases, the one or more features of the machine learning model corresponds to information about the sample composition, source, identity, and/or information about one or more conditions associated with the sample. In some cases, the one or more features of the machine learning model corresponds to the sample matrix. In some cases, the one or more features of the machine learning model corresponds to the source of the sample (e.g., fermentation medium, blood sample, plasma sample, urine sample, food sample). In some cases, the quality of machine learning models is measured by a fit statistic. In some cases, the fit statistic is R-squared. In some cases, the machine learning model is trained using a data set comprising impurities, such as 1%, 2%, 3%, 4%, 5%, 6%, 7%, 8%, 9%, 10%, 15%, or 20% impurities by mass.

In some cases, the machine learning model maps multiple factors affecting ionization. In some cases, the machine learning model enables instantaneous and/or accurate determination of an absolute concentration of one or more analytes. In some instances, the machine learning model is trained on the one or more reference samples. In some cases, the machine learning models provide scalable metabolomics. In some cases, the machine learning model (e.g., deep learning) is scalable for new types of analyses. In some cases, the machine learning model (e.g., deep learning) provides absolute quantification.

In some cases, the machine learning model allows for comparison between different runs. A run may generally refer to analyzing and processing one or more analytes using LC-MS and a signal processing module comprising a machine learning method, as described herein.

A machine learning model can comprise a supervised, semi-supervised, unsupervised, or self-supervised machine learning model. In some cases, the one or more ML approaches perform classification or clustering of the MS data. In some examples, the machine learning approach comprises a classical machine learning method, such as, but not limited to, support vector machine (SVM) (e.g., one-class SVM, linear or radial kernels, etc.), K-nearest neighbor (KNN), isolation forest, random forest, logistic regression, AdaBoost classifier, extra trees classifier, extreme gradient boosting, gaussian process classifier, gradient boosting classifier, light gradient boosting, linear discriminant analysis, naïve Bayes, quadratic discriminant analysis, ridge classifier, or any combination thereof. In some examples, the machine learning approach comprises a deep leaning method (e.g., deep neural network (DNN)), such as, but not limited to a fully-connected network, convolutional neural network (CNN) (e.g., one-class CNN), recurrent neural network (RNN), transformer, graph neural network (GNN), convolutional graph neural network (CGNN), multi-level perceptron (MLP), or any combination thereof.

In some embodiments, a classical ML method comprises one or more algorithms that learns from existing observations (i.e., known features) to predict outputs. In some embodiments, the one or more algorithms perform clustering of data. In some examples, the classical ML algorithms for clustering comprise K-means clustering, mean-shift clustering, density-based spatial clustering of applications with noise (DBSCAN), expectation-maximization (EM) clustering (e.g., using Gaussian mixture models (GMM)), agglomerative hierarchical clustering, or any combination thereof. In some embodiments, the one or more algorithms perform classification of data. In some examples, the classical ML algorithms for classification comprise logistic regression, naïve Bayes, KNN, random forest, isolation forest, decision trees, gradient boosting, support vector machine (SVM), or any combination thereof. In some examples, the SVM comprises a one-class SMV or a multi-class SVM.

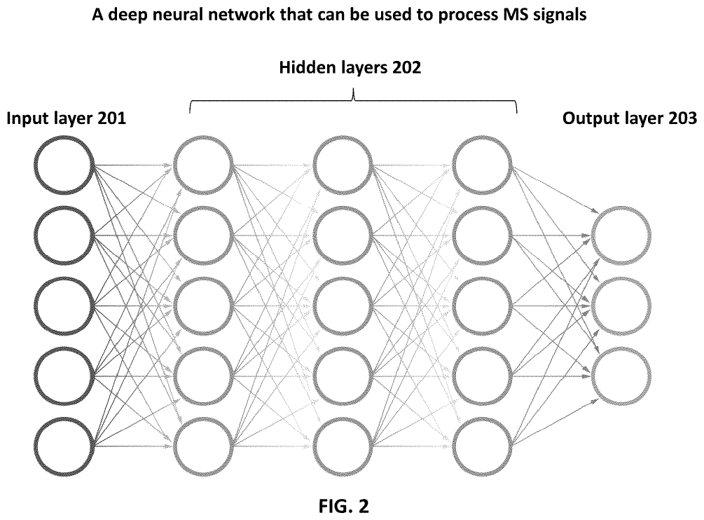

In some embodiments, the deep learning method comprises one or more algorithms that learns by extracting new features to predict outputs. In some embodiments, the deep learning method comprises one or more layers, as illustrated in FIG. 2. In some embodiments, the deep learning method comprises a neural network (e.g., DNN comprising more than one layer). Neural networks generally comprise connected nodes in a network, which can perform functions, such as transforming or translating input data. In some embodiments, the output from a given node is passed on as input to another node. The nodes in the network generally comprise input units in an input layer 201, hidden units in one or more hidden layers 202, output units in an output layer 203, or a combination thereof. In some embodiments, an input node is connected to one or more hidden units. In some embodiments, one or more hidden units is connected to an output unit. The nodes can generally take in input through the input units and generate an output from the output units using an activation function. In some embodiments, the input or output comprises a tensor, a matrix, a vector, an array, or a scalar. In some embodiments, the activation function is a Rectified Linear Unit (ReLU) activation function, a sigmoid activation function, a hyperbolic tangent activation function, or a Softmax activation function.

The connections between nodes can further comprise weights for adjusting input data to a given node (i.e., to activate input data or deactivate input data). In some embodiments, the weights are learned by the neural network. In some embodiments, the neural network is trained to learn weights using gradient-based optimizations. In some embodiments, the gradient-based optimization comprises one or more loss functions. In some embodiments, the gradient-based optimization is gradient descent, conjugate gradient descent, stochastic gradient descent, or any variation thereof (e.g., adaptive moment estimation (Adam)). In some further embodiments, the gradient in the gradient-based optimization is computed using backpropagation. In some embodiments, the nodes are organized into graphs to generate a network (e.g., graph neural networks). In some embodiments, the nodes are organized into one or more layers to generate a network (e.g., feed forward neural networks, convolutional neural networks (CNNs), recurrent neural networks (RNNs), etc.). In some embodiments, the CNN comprises a one-class CNN or a multi-class CNN.

In some embodiments, the neural network comprises one or more recurrent layers. In some embodiments, the one or more recurrent layers are one or more long short-term memory (LSTM) layers or gated recurrent units (GRUs). In some embodiments, the one or more recurrent layers perform sequential data classification and clustering in which the data ordering is considered (e.g., time series data). In such embodiments, future predictions are made by the one or more recurrent layers according to the sequence of past events. In some embodiments, the recurrent layer retains or “remembers” important information, while selectively “forgets” what is not essential to the classification.

In some embodiments, the neural network comprise one or more convolutional layers. In some embodiments, the input and the output are a tensor representing variables or attributes in a data set (e.g., features), which may be referred to as a feature map (or activation map). In such embodiments, the one or more convolutional layers are referred to as a feature extraction phase. In some embodiments, the convolutions are one-dimensional (ID) convolutions, two dimensional (2D) convolutions, three dimensional (3D) convolutions, or any combination thereof. In further embodiments, the convolutions are ID transpose convolutions, 2D transpose convolutions, 3D transpose convolutions, or any combination thereof.

The layers in a neural network can further comprise one or more pooling layers before or after a convolutional layer. In some embodiments, the one or more pooling layers reduces the dimensionality of a feature map using filters that summarize regions of a matrix. In some embodiments, this down samples the number of outputs, and thus reduces the parameters and computational resources needed for the neural network. In some embodiments, the one or more pooling layers comprises max pooling, min pooling, average pooling, global pooling, norm pooling, or a combination thereof. In some embodiments, max pooling reduces the dimensionality of the data by taking only the maximums values in the region of the matrix. In some embodiments, this helps capture the most significant one or more features. In some embodiments, the one or more pooling layers is one dimensional (ID), two dimensional (2D), three dimensional (3D), or any combination thereof.

The neural network can further comprise of one or more flattening layers, which can flatten the input to be passed on to the next layer. In some embodiments, a input (e.g., feature map) is flattened by reducing the input to a one-dimensional array. In some embodiments, the flattened inputs can be used to output a classification of an object. In some embodiments, the classification comprises a binary classification or multi-class classification of visual data (e.g., images, videos, etc.) or non-visual data (e.g., measurements, audio, text, etc.). In some embodiments, the classification comprises binary classification of an image (e.g., cat or dog). In some embodiments, the classification comprises multi-class classification of a text (e.g., identifying hand-written digits)). In some embodiments, the classification comprises binary classification of a measurement. In some examples, the binary classification of a measurement comprises a classification of a system's performance using the physical measurements described herein (e.g., normal or abnormal, normal or anormal).

The neural networks can further comprise of one or more dropout layers. In some embodiments, the dropout layers are used during training of the neural network (e.g., to perform binary or multi-class classifications). In some embodiments, the one or more dropout layers randomly set some weights as 0 (e.g., about 10%, 20%, 30%, 40%, 50%, 60%, 70%, 80% of weights). In some embodiments, the setting some weights as 0 also sets the corresponding elements in the feature map as 0. In some embodiments, the one or more dropout layers can be used to avoid the neural network from overfitting.

The neural network can further comprise one or more dense layers, which comprises a fully connected network. In some embodiments, information is passed through a fully connected network to generate a predicted classification of an object. In some embodiments, the error associated with the predicted classification of the object is also calculated. In some embodiments, the error is backpropagated to improve the prediction. In some embodiments, the one or more dense layers comprises a Softmax activation function. In some embodiments, the Softmax activation function converts a vector of numbers to a vector of probabilities. In some embodiments, these probabilities are subsequently used in classifications, such as classifications of a type or class of a molecule (e.g., calibrator or analyte) as described herein.

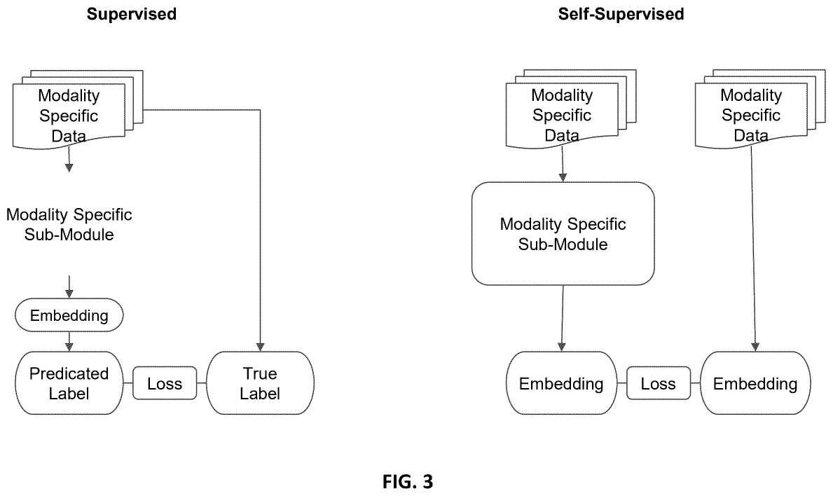

The machine learning model can comprise one or more sub-models. In some cases, the one or more sub-models are trained individually. Individual sub-models and their training are schematically illustrated in FIG. 3. While multi-modality networks are extremely powerful, they typically require that training samples have all the associated modality data during training. In some cases, with scientific data this is not the case. The models described herein can comprise modularity by design, allowing flexibility by training individual modules based on available data. Depending on the module, this can allow for utilizing both in-house and external data. This can comprise both supervised and a variety of self-supervised training regimes. Modules can then be used as part of the foundation model or individually as part of another task specific dataset model.

In some cases, the training data comprises MS data. In some cases, the machine learning model is trained using a data set comprising a reference analyte, a calibrator, or a combination thereof. In some cases, the machine learning model is trained using a data set comprising (i) a first set of intensity values for one or more reference analytes having a known concentration and (ii) a second set of intensity values for one or more reference calibrators having a known concentration. In some instances, the reference analytes and the one or more analytes in the sample mixture comprise a same analyte or a same type or class of analyte. In some instances, the reference calibrators and the one or more calibrators in the sample mixture comprise a same calibrator or a same type or class of calibrator.

The training data may be designed based on one or more considerations. Considerations may comprise, by way of non-limiting example, effective LC separation of the broadest range of analytes, instrumental conditions for collective sensitivity of all analytes (ionization mode, RT, extracted ion chromatogram for each analyte), inherent range (high and low) of instrument detection (for each analyte), length of time between injections (acquisition and column equilibration), stability and reproducibility over long acquisition times, and/or use of spiked-in non-endogenous QC analytes to demarcate between sample issues and instrument issues.

For example, training data may comprise raw spectra comprising data on a plurality of analytes collected on a plurality of instruments. The instruments can comprise two or more different mass spectrometer types (e.g. ion trap, orbitrap, FT-ICR, time-of-flight (ToF), or QQQ-time-of-flight (QTOF) mass spectrometers) provided that each mass spectrometer has sufficient resolution to provide an exact mass of analyte ions. The instruments can comprise two or more different mass spectrometers of the same type. Training data may not require optimized or even effective chromatographic separation. Inclusion of the one or more design considerations in building the training set can produce a model which is capable of analyte quantitation independent of the particular design factor (e.g. a model built using a plurality of different mass spectrometer types can quantitate analytes using data collected from any mass spectrometer type included in the training set).

The methods described herein may not comprise an AUC (or similar construct). Since there is no AUC, the demands on the acquisition method are not a stringent as those in traditional LC-MS method development. Specifically, it can be possible for use to record a 5-minute method with high resolution and positive and negative switching because we do not need to record a specific number of “point” in each XIC. Further, the LC performance of each analyte does not have as stringent “appearance” requirements as traditional analytical method development (i.e., baseline separation and ideal peak shape are not as critical).

For example, models described herein are capable of providing accurate predictive classifiers of an absolute quantitation of two or more analytes of interest using chromatographic methods wherein the two or more analytes of interest overlap in time by at least 70%, 60%, 50%, 40%, or 30% (e.g. wherein the analyte peaks are only 30%, 40%, 50%, 60%, or 70% resolved).

As a further example, models described herein are capable of providing accurate predictive classifiers of absolute quantitation of analytes which produce chromatographic peaks with an asymmetric factor greater than 1.2 (e.g. 1.5, 2.0, 2.5, or greater than 3) or less than 0.9 (e.g. 0.8, 0.7, 0.6, 0.5, or less than 0.5).

The training data sets can be used as possible bioprocessing scenarios, such as those a user may detect in their workflow. In some cases, the training data sets are created to simulate a target bioprocessing event or scenario. In some cases, the training data sets created can aid a machine learning model to detect target analytes at a particular range. One challenges in training set creation may be to know and create a priori the concentration ranges at which the target analytes can and will be detected in.

The software infrastructure for the training data set may comprise a database and a platform for data collection. In some cases, the database comprises an internal compounds database which is used for adding, updating, searching, filtering and/or exploring sample data and/or predictive classifiers. The database can be a reference for both bench scientists who use it for examining molecular properties and biological pathway connectivity, as well as data scientists who use it for time-trackable metrics. The platform for data collection may comprise raw data and metadata collection and retrieval, conversion, quality control, storage and/or monitoring. In some cases, the platform designs the plates for training and creates the work lists to run in the lab. In some cases, the platform defines spotting patterns for stock solutions. In some cases, the platform automates partially or completely automates the laboratory workflows provided herein.

The samples and/or predictive classifiers databased may comprise elements for distinguishing between samples, compounds, biomarkers, and/or phenotypes associated with the samples. In some cases, the element comprises chemical properties, such as, but not limited to, chemical name, SMILES string, physiochemical properties. In some cases, the element comprises analytical properties, such as, but not limited to ionization mode(s) and typical adducts formed. In some cases, the element comprises biological information, such as a Human Metabolome Database (HMDB) link, Kyoto Encyclopedia of Genes and Genomes (KEGG) link, and pathway information. In some cases, the element comprises the training status.

The training set can be created by obtaining data using techniques described herein. For example, samples are prepared and analyzed via LC-MS. The workflow for generating plates for training may comprise analyte stocks and plate layouts from a software being combined in a laboratory equipment. In some cases, sample preparation comprises distributing stock solutions in varying concentrations. In some cases, a multi-drop system add an addition fixed volume of the selected matrix onto spotted wells. One or more calibrators or quality control metrics can be added to the LC-MS, and a run list may be created by a software to generate and process plates for training sets. In some cases, a MS run list is provided by a user interface. In some instances, the user interface comprises information such as sample plate positions, blank positions, calibration curve positions, number of drawers, number of slots per drawer, columns to run, blank plate number of wells, number of injections, plates between calibration curves, maximum blank well reuse, injection volume, blank frequency, etc. In some cases, prior to downloading instructions to an instrument, a user is provided with a visual quality control of the volume for each analyte to be spotted. In some instances, the visual quality control comprises a heat map key, for example, in unit volumes such as uL.

In some cases, an experimental browser is used to access training set data. For example, information may be downloadable as a CSV. In some examples, the format of the downloaded information is suitable for uploading for instrument acquisition. In some cases, the experimental browser comprises the source plate layout, a downloadable MS run list, concentrations spiked in each well, details on trained analytes, or a combination thereof.

The platforms generating training sets described herein may comprise highly scalable backend database storing chemical experiment entities. The platforms may further comprise frontend for creating new entities and combining existing to describe chemical protocols, frontend for uploading RAW files to cloud storage, automatic conversion and logging pipelines of RAW files to ML-friendly format, QC pipeline steps, large collection of visualizations, filtering and transformations which can be applied to ML-dataset samples, built-in logging of experimental metadata to backend database (e.g., known compound concentrations for training dataset), and/or MS automated workflow components, such as sample preparation (e.g., cherry pick list creation) or worklist creation for autosampler (e.g., highly configurable based on common workflow changes).

In some cases, prior to training, each analyte is screened to optimize detection and performance in training. The one or more analytes may be screened based on ionization mode(s), detected adducts, LC elution profile and retention time, limit of detection in water, limit of detection in cell lysate, and/or any observed issues with stability or solubility. The analytical information can then be captured and stored, for example in a database such as a compounds database.

The model quality may be dependent on data quality and training set acquisition. In some cases, the training set is analyzed using traditional MS analysis. In some cases, the data is used to assess traditional analytical performance of the methods to ensure quality control. For example, a predictive classifier and MS data may be processed by a signal processing module comprising a machine learning model (e.g., deep learning model and/or one or more transformers) to determine a correct predictive classifier value for one or more samples in a test set. In such an example, the MS data may also be used by a software that can control of a LC-MS system to output a values such as mass-to-charge ratio, retention time, AUC, etc., for each analyte. This can be used to assess analytical performance.

In some cases, the computing system is configured to process the MS data using a trained ML algorithm to determine a predictive classifier associated with one or more samples. In some instances, the trained ML algorithm comprises a classical ML algorithm, a deep learning algorithm, or a combination thereof. In some examples, the ML algorithm comprises a neural network. In some examples, the neural network is a deep neural network. In some cases, the ML algorithm is configured to determine the predictive classifier of the one or more samples based on (1) a first set of intensity values for one or more analytes in the sample mixture and/or (2) a second set of intensity values for the one or more reference points in the sample mixture. In some cases, the absolute concentration of the one or more analytes is based at least in part on a relationship or correlation between an MS signal associated with a sample and an MS signal associated with one or more signals of one or more training samples.

In some cases, the computing system is configured to output one or more actionable biological insights based on the absolute concentration of the analytes. In some instances, the trained ML algorithm is configured to determine the absolute concentration of the analytes from the received MS data substantially in real time. In some examples, the one or more actionable biological insight comprises a cell response or a cell behavior. In some examples, the cell response or the cell behavior is used to optimize a media in order to promote or facilitate cell culturing or cell growth. In some examples, the media is optimized in real time based on the cell response or the cell behavior.

In some cases, the analysis of the one or more analytes by the MS device and the computing system comprises a high-throughput analysis. In some instances, the total runtime comprises about 0.1 seconds, 0.5 seconds, 1 second, 2 seconds, 10 seconds, 30 seconds, 1 minute, 2 minutes, 3 minutes, 4 minutes, 5 minutes, 10 minutes, or 15 minutes. In particular embodiments, the total method run time is less than 1 minute, less than 2 minutes, less than 3 minutes, less than 5 minutes, less than 10 minutes, or less than about 12 minutes. In some cases, the total runtime comprises a data acquisition time and a data analysis time. In some cases, the data acquisition time and the data analysis time occur sequentially (e.g. they add together to make up the total analysis time). In some cases, the data acquisition time and the data analysis time occur in parallel, whereby the total analysis time per sample of the high-throughput system is limited by the longer of the data acquisition and data analysis time (e.g. the data acquisition can be determinative of the total runtime due to the time required for chromatographic separation). In some cases, the number of samples analyzed per hour is at least 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 50, or 60.

### Computer Systems

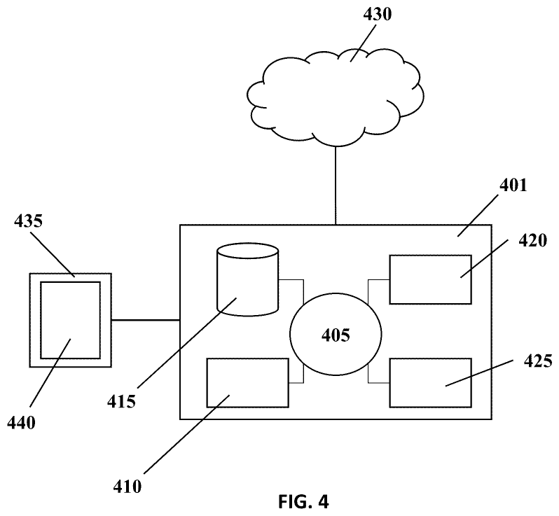

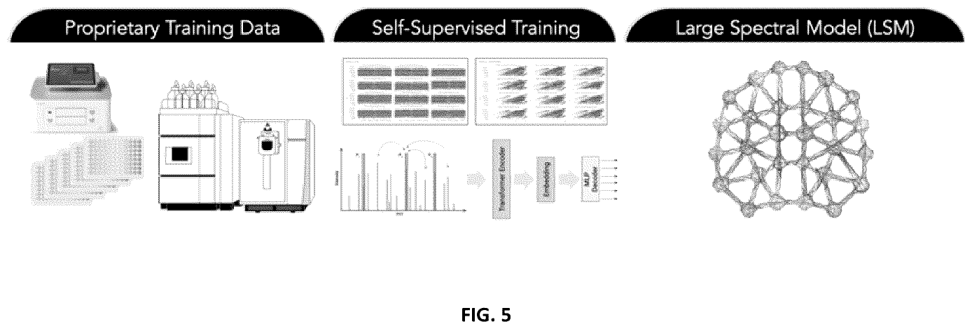

In an aspect, the present disclosure provides computer systems that are programmed or otherwise configured to implement methods of the disclosure, e.g., a method or a system for generating one or more predictive classifiers associated with a one or more samples. FIG. 4 shows a computer system 401 that is programmed or otherwise configured to implement a method for determining an absolute concentration of the analytes from mass-spectrometry (MS) data. The computer system 401 may be configured to, for example, (i) receive MS data from the MS machine, wherein the MS data is associated with a sample comprising one or more analytes and one or more calibrators, (ii) process the MS data using a trained ML algorithm to determine an absolute concentration of the analytes, and (iii) output one or more actionable biological insights based on the absolute concentration of the analytes, wherein the trained ML algorithm is configured to determine the absolute concentration of the analytes from the received MS data substantially in real time. The computer system 401 can be an electronic device of a user or a computer system that is remotely located with respect to the electronic device. The electronic device can be a mobile electronic device.

The computer system 401 may include a central processing unit (CPU, also “processor” and “computer processor” herein) 405, which can be a single core or multi core processor, or a plurality of processors for parallel processing. The computer system 401 also includes memory or memory location 410 (e.g., random-access memory, read-only memory, flash memory), electronic storage unit 415 (e.g., hard disk), communication interface 420 (e.g., network adapter) for communicating with one or more other systems, and peripheral devices 425, such as cache, other memory, data storage and/or electronic display adapters. The memory 410, storage unit 415, interface 420 and peripheral devices 425 are in communication with the CPU 405 through a communication bus (solid lines), such as a motherboard. The storage unit 415 can be a data storage unit (or data repository) for storing data. The computer system 401 can be operatively coupled to a computer network (“network”) 430 with the aid of the communication interface 420. The network 430 can be the Internet, an internet and/or extranet, or an intranet and/or extranet that is in communication with the Internet. The network 430 in some cases is a telecommunication and/or data network. The network 430 can include one or more computer servers, which can enable distributed computing, such as cloud computing. The network 430, in some cases with the aid of the computer system 401, can implement a peer-to-peer network, which may enable devices coupled to the computer system 401 to behave as a client or a server.

The CPU 405 can execute a sequence of machine-readable instructions, which can be embodied in a program or software. The instructions may be stored in a memory location, such as the memory 410. The instructions can be directed to the CPU 405, which can subsequently program or otherwise configure the CPU 405 to implement methods of the present disclosure. Examples of operations performed by the CPU 405 can include fetch, decode, execute, and writeback.

The CPU 405 can be part of a circuit, such as an integrated circuit. One or more other components of the system 401 can be included in the circuit. In some cases, the circuit is an application specific integrated circuit (ASIC).

The storage unit 415 can store files, such as drivers, libraries and saved programs. The storage unit 415 can store user data, e.g., user preferences and user programs. The computer system 401 in some cases can include one or more additional data storage units that are located external to the computer system 401 (e.g., on a remote server that is in communication with the computer system 401 through an intranet or the Internet).

The computer system 401 can communicate with one or more remote computer systems through the network 430. For instance, the computer system 401 can communicate with a remote computer system of a user. Examples of remote computer systems include personal computers (e.g., portable PC), slate or tablet PC's (e.g., Apple® iPad, Samsung® Gala3 Tab), telephones, Smart phones (e.g., Apple® iPhone, Android-enabled device, Blackberiy®), or personal digital assistants. The user can access the computer system 401 via the network 430.

Methods as described herein can be implemented by way of machine (e.g., computer processor) executable code stored on an electronic storage location of the computer system 401, such as, for example, on the memory 410 or electronic storage unit 415. The machine executable or machine-readable code can be provided in the form of software. During use, the code can be executed by the processor 405. In some cases, the code can be retrieved from the storage unit 415 and stored on the memory 410 for ready access by the processor 405. In some situations, the electronic storage unit 415 can be precluded, and machine-executable instructions are stored on memory 410.

The code can be pre-compiled and configured for use with a machine having a processor adapted to execute the code or can be compiled during runtime. The code can be supplied in a programming language that can be selected to enable the code to execute in a pre-compiled or as-compiled fashion.

Aspects of the systems and methods provided herein, such as the computer system 401, can be embodied in programming. Various aspects of the technology may be thought of as “products” or “articles of manufacture” typically in the form of machine (or processor) executable code and/or associated data that is carried on or embodied in a type of machine-readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine-readable medium, such as computer-executable code, may take many forms, including but not limited to, a tangible storage medium, a carrier wave medium or physical transmission medium. Non-volatile storage media including, for example, optical or magnetic disks, or any storage devices in any computer(s) or the like, may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 401 can include or be in communication with an electronic display 435 that comprises a user interface (UI) 440 for providing, for example, a portal for a user to identify and/or view one or more MS data or ML algorithm. The portal may be provided through an application programming interface (API). A user or entity can also interact with various elements in the portal via the UI. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 405. For example, the algorithm may determine one or more predictive classifiers associated with a sample.

### Samples

In some embodiments, the methods described herein are performed on one or more samples. In some embodiments, the one or more samples are biological samples. In various embodiments, the one or more samples include one or more metabolites and one or more backgrounds or matrices. In certain embodiments, the sample is an aqueous solution including one or more metabolites for determination. In other embodiments, the sample is an organic solution including one or more metabolites for determination. In yet other embodiments, the sample includes one or more metabolites that have been derivatized or functionalized prior to analysis.

In some the one or more matrices may be selected from the group consisting of a fermentation broth, a cell culture medium, a tissue culture medium, urine, fecal matter, blood, blood plasma mucus, saliva, or soil. In certain embodiments, the matrix includes one or more salts. In particular variations, the one or more salts include sodium ions, potassium ions, calcium ions, magnesium ions or ammonium cations. In other variations, the one or more salts include chloride, nitrate, sulfate, phosphate, formate, acetate, or citrate anions. In a particular embodiment, the salt is sodium chloride. In other variations, the matrix includes one or more acids or bases. In particular variations, the matrix includes hydrochloric acid, sulfuric acid, phosphoric acid, sodium hydroxide, potassium hydroxide, ammonium hydroxide, or acetic acid. In certain embodiments, the matrix includes a buffer. In a particular embodiment, the matrix includes a citrate, phosphate, or acetate buffer.

In some embodiments, the sample is produced by a microbial community, such as a microbiome. In various embodiments, the microbiome samples can be obtained from a human, an animal, a plant, a seed, a soil, or an environment. In some embodiments, the microbiome sample is a sample of a gastrointestinal tract (e.g., stomach), skin, mammary glands, placenta, seminal fluid, uterus, ovarian follicles, lung, saliva, oral mucosa, conjunctiva, or biliary tract.

### High-Resolution Mass Spectrometry

In various embodiments, the mass accuracy is less than or equal to 75 ppm, less than or equal to 30 ppm, less than or equal to 15 ppm, less than or equal to 10 ppm, or less than or equal to 5 ppm.

### Acquisition Parameters

In some embodiments, the acquisition parameters of the mass spectrometer are set based on a method used for training a fine-tune model comprised in the machine learning model. In various embodiments, the acquisition parameters are programmed into the instrument to control the mass spectrometer operation. In some embodiments, the acquisition parameters are programmed into the mass spectrometer instrument in the form of a script read by the instrument or the software package that controls the instrument. In some embodiments, the acquisition parameters are programmed into the mass spectrometer in advance of the acquisition period. In other embodiments, the acquisition parameters are programmed into the instrument during the signal acquisition process. In particular embodiments, the acquisition parameters are programmed into the instrument during the signal acquisition process based on the value of the signal measured during the acquisition process.

In certain embodiments, the acquisition parameter programmed into the instrument is the acquisition mode. In particular embodiments, the acquisition mode is set to scan mode. In other embodiments, the acquisition mode is set to selected ion mode. In yet other embodiments, the acquisition mode is set to parallel reaction monitoring mode.

In certain embodiments, the acquisition parameter programmed into the instrument is the ionization mode. In particular embodiments, the ionization mode is positive ionization mode or negative ionization mode.

In certain embodiments, the acquisition parameter programmed into the instrument is the automatic gain control (AGC) setting. In particular embodiments, the AGC setting programmed into the instrument is 1%, 5%, 10%, 15%, 20%, 30%, 40%, 50%, 60%, 70%, 80%, 90%, 100%, 120%, 140%, 160%, 180%, 200%, 300%, 400%, 500%, 1000%, 5000%, 1000%, or unlimited.

In certain embodiments, the acquisition parameter programmed into the instrument is the acquisition time (also sometimes called the injection time). In particular embodiments, the acquisition time is set to 1 ms, 5 ms, 10 ms, 50 ms, 100 ms, 200 ms, 300 ms, 400 ms, 500 ms, 600 ms, 700 ms, 800 ms, 900 ms, 1000 ms, 1500 ms, 2000 ms, 2500 ms, 3000 ms, 4000 ms, 5000 ms, 10000 ms, 20000 ms, 50000 ms, 10 s, 20 s, 30 s, 60 s, 1 min, 2 min, 3 min, 4, min, 5, min, or 10 min.

In certain embodiments, the acquisition parameter programmed into the instrument is the molecular weight (MW) width. In particular embodiments, the MW width is 1 g/mol, 2 g/mol, 3 g/mol, 4 g/mol, 5 g/mol, 6 g/mol, 7 g/mol, 8 g/mol, 9 g/mol, 10 g/mol, 15 g/mol, 20 g/mol, 30 g/mol, 40 g/mol, 50 g/mol, 60 g/mol, 70 g/mol, 80 g/mol, 90 g/mol, 100 g/mol, 200 g/mol, 300 g/mol, 400 g/mol, 500 g/mol, 600 g/mol, 700 g/mol, 800 g/mol, 900 g/mol, 1000 g/mol, 1500 g/mol, 2000 g/mol, 3000 g/mol, 4000 g/mol, 5000 g/mol, 10000 g/mol, 20000 g/mol, 50000 g/mol. In other embodiments, the MW width is 1 m/z, 2 m/z, 3 m/z, 4 m/z, 5 m/z, 6 m/z, 7 m/z, 8 m/z, 9 m/z, 10 m/z, 15 m/z, 20 m/z, 30 m/z, 40 m/z, 50 m/z, 60 m/z, 70 m/z, 80 m/z, 90 m/z, 100 m/z, 200 m/z, 300 m/z, 400 m/z, 500 m/z, 600 m/z, 700 m/z, 800 m/z, 900 m/z, 1000 m/z, 1500 m/z, 2000 m/z, 3000 m/z, 4000 m/z, 5000 m/z, 10000 m/z, 20000 m/z, 50000 m/z.

In certain embodiments, the acquisition parameter programmed into the instrument is the molecular weight (MW) scan range. In particular embodiments, the scan range is set to 10-5000 m/z, 20-2000 m/z, 30-3000 m/z, 50-1000 m/z, 50-500 m/z, 60-325 m/z or 60-200 m/z.

In other embodiments, the scan range is centered on or near the mass of a target metabolite and the scan width is used to set the minimum and maximum of the scan range. In particular embodiments, the scan range or scan width is chosen to account for variability in the detector response envelope function. In one embodiment, the scan range or scan width is chosen to extend the acquisition range to greater than that of a target molecule or standard molecular masses to increase the uniformity of the instrument response envelope function across the one or more metabolites or standards.

In some embodiments, the acquisition parameter programmed into the instrument is the instrument resolution.

### Acquisition Windows and Programs

In some embodiments, the total instrument acquisition period is subdivided into one or more acquisition windows, each with its own corresponding set of instrument acquisition parameters. In various embodiments, one or more acquisition windows are combined into an instrument acquisition program including a sequence of one or more acquisition windows. In particular embodiments, one or more acquisition windows in the acquisition program correspond to different instrument acquisition parameter settings. In a particular embodiment, one or more acquisition windows corresponds to a choice of settings for the instrument acquisition mode, ionization mode, scan range, scan width, automatic gain control setting and acquisition time. In a particular embodiment, one or more acquisition windows in an acquisition program correspond to distinct instrument parameter settings. In a particular embodiment, the sequence of acquisition windows in the acquisition program contains at least 2, 3, 4, 5, 6, 7, 8, 9, 10, 11, 12, 13, 14, 15, 16, 17, 18, 19, 20, 21, 22, 23, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 110, 120, 130, 140, 150, 160, 170, 180, 190, 200, 225, 250, 275, 300, 350, 400, 500, 600, 700, 800, 900, or 1000 windows.

In certain embodiments the acquisition windows are determined algorithmically based on the number and identity of the one or more metabolites to be determined in the sample. In particular embodiments, the acquisition program including the one or more acquisition windows is programmed into the instrument. In one embodiment, the acquisition program including the one or more acquisition windows is programmed into the instrument using a script read by the instrument or the software controlling the instrument.

In various embodiments, the acquisition program including two or more acquisition windows increases the number of detectable or quantifiable metabolites compared to an acquisition program including fewer acquisition windows. In a particular embodiment the acquisition program including two or more acquisition windows increases the number of detectable or quantifiable metabolites compared to an acquisition program with a static set of acquisition parameters. In various embodiments, the relative increase in the number of detectable or quantifiable metabolites compared to an acquisition program including a static set of acquisition parameters is at least 5%, 10%, 15%, 20%, 30%, 40%, 50%, 60%, 70%, 80%, 90%, 100%, 150%, 200%, 250%, 300%, 400%, 500%, 1000%, or 10000%.

In various embodiments the acquisition program including two or more acquisition windows decreases the signal interference between detectable or quantifiable metabolites compared to an acquisition program including fewer acquisition windows.

### Method Cycle Time and Throughput

In some embodiments, the methods described herein pertain to high-throughput analysis. In particular embodiments, the total method runtime is about 0.1 seconds, 0.5 seconds, 1 second, 2 seconds, 10 seconds, 30 seconds, 1 minute, 2 minutes, 3 minutes, 4 minutes or 5 minutes. In particular embodiments, the total method run time is less than 1 minute, less than 2 minutes, less than 3 minutes, less than 5 minutes, or less than 10 minutes. In certain embodiments, the number of samples analyzed per hour is at least 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 50, or 60.

### Computer Implementation

Methods described herein, or portions of the methods described herein are, in some embodiments, performed on one or more computers. For example, portion of the methods for generating one or more predictive classifier associated with a biological sample may be performed on one or more computers.

As a specific example, the training and deployment of a machine-learned model that generates one or more predictive classifiers associated with a biological sample can be implemented in hardware or software, or a combination of both. In one embodiment of the invention, a machine-readable storage medium is provided, the medium including a data storage material encoded with machine readable data which, when using a machine programmed with instructions for using said data is capable of displaying any of the datasets and execution and results of methods described herein. Methods disclosed herein can be implemented in computer programs executing on programmable computers, including a processor, a data storage system (including volatile and non-volatile memory and/or storage elements), a graphics adapter, a pointing device, a network adapter, at least one input device, and at least one output device. A display is coupled to the graphics adapter. Program code is applied to input data to perform the functions described above and generate output information. The output information is applied to one or more output devices, in known fashion. The computer can be, for example, a personal computer, microcomputer, or workstation of conventional design.

Each program can be implemented in a high-level procedural or object oriented programming language to communicate with a computer system. However, the programs can be implemented in assembly or machine language, if desired. In any case, the language can be a compiled or interpreted language. Each such computer program is preferably stored on a storage media or device (e.g., ROM or magnetic diskette) readable by a general or special purpose programmable computer, for configuring and operating the computer when the storage media or device is read by the computer to perform the procedures described herein. The system can also be considered to be implemented as a computer-readable storage medium, configured with a computer program, where the storage medium so configured causes a computer to operate in a specific and predefined manner to perform the functions described herein.

The signature patterns and databases thereof can be provided in a variety of media to facilitate their use. “Media” refers to a manufacture that contains the signature pattern information of the present invention. The databases of the present invention can be recorded on computer readable media, e.g. any medium that can be read and accessed directly by a computer. Such media include, but are not limited to: magnetic storage media, such as floppy discs, hard disc storage medium, and magnetic tape; optical storage media such as CD-ROM; electrical storage media such as RAM and ROM; and hybrids of these categories such as magnetic/optical storage media. One of skill in the art can readily appreciate how any of the presently known computer readable mediums can be used to create a manufacture including a recording of the present database information. “Recorded” refers to a process for storing information on computer readable medium, using any such methods as known in the art. Any convenient data storage structure can be chosen, based on the means used to access the stored information. A variety of data processor programs and formats can be used for storage, e.g. word processing text file, database format, etc.

The following examples are meant to illustrate the invention. They are not meant to limit the invention in any way.

### EXAMPLES

### Example 1: Training Dataset

A dataset for training fundamental semantic machine learning models, such as the large spectral models described herein, to directly understand raw mass spectrometry data was assembled from 14.5 million mass spectra generated from a broad set of instruments, instrument parameters, and sample types.

TABLE 1
Ranges of instrument configurations and parameters used to generate a training data set

| Instrument | |
|---|---|
| Parameter | Variations |
| Chromatography | Reversed Phase (RP), Hydrophilic Interaction Liquid Chromatography (HILIC), Charged |
| Type | Surface Hybrid (CSH) |
| Chromatography | Thermo Dionex Ultimate 3000, Shimadzu Nexera X2, Thermo Scientific ™ Vanquish ™ |
| Instrument | UPHPLC, Agilent 6890N (Gas Chromatography), Waters Acquity I-Class, Agilent 1220 |
| | Infinity, Thermo Vanquish ™ Flex UHPLC, Waters BEH Amide column |
| Chromatographic | ACE Excel 2 C18-PFP (100 × 2.1 mm, 2 um), Waters Atlantis HILIC (150 × 2.1 mm), |
| Column | Thermo Fisher Accucore HILIC (50 × 2.1 mm, 2.6 um) with Thermo accucore HILIC |
| | guard cartridge, Thermo Fisher Accucore C18 (50 × 2.1 mm, 2.6 um), Waters ACQUITY |
| | UPLC HSS T3 (100 × 2.1 mm, 3 um), Waters XBridge Amide (100 × 4.6 mm, 3.5 um), |
| | Waters Acquity CSH C18 (100 × 2.1 mm, 1.7 um), Restek Rtx-5Sil (30 m × |
| | 0.25 mm, 0.25 um), SeQuant ZIC-pHILIC (150 × 2.1 mm, 5 um), Waters Acquity UPLC |
| | HSS Cyano (100 × 2.1 mm, 1.8 um), Ascentis Express HILIC HPLC (150 × |
| | 2.1 mm, 2.7 um), Agilent Zorbax Eclipse Plus C18 (150 × 4.6 mm, 3.5 um), Waters XBridge |
| | BEH Amide XP HILIC (50 × 2.1 mm × 2.5 um) with Thermo Accucore HILIC guard, |
| | Higgins endcapped C18 stainless steel (50 × 2.1 mm, 3 um), Product #TS-0521-C183; |
| | Thermo Accucore C18 guard with holder, Product #17126-014005, ACE Excel 2 C18- |
| | PFP (100 × 2.1 mm, 2 um), Acquity UHPLC HSS T3 column (100 × 2.1 mm, 1.8 μm |
| | particle size), |
| Chromatographic | 0.150 mL/min-0.700 mL/min |
| Flow Rate | |
| LC Solvents | Solvent A: 100% water; 0.1% formic acid - Solvent B: 100% acetonitrile |
| | Solvent A: 100% water; 0.1% formic acid; 10 mM ammonium formate - Solvent B: |
| | 100% acetonitrile; 0.1% formic acid |
| | Solvent A: 100% water - Solvent B: 100% acetonitrile |
| | Solvent A: 100% water; 0.1% formic acid - Solvent B: 100% methanol; 0.1% formic acid |
| | Solvent A: 85% acetonitrile/15% water; 10 mM ammonium carbonate - 40% |
| | acetonitrile/60% water; 10 mM ammonium carbonate |
| | Solvent A: 95% acetonitrile/5% water; 0.1% acetic acid; 10 mM ammonium acetate, - |
| | Solvent B: 95% water/5% acetonitrile; 0.1% acetic acid; 10 mM ammonium acetate |
| | Solvent A: 100% water; 0.5% formic acid; 5 mM of ammonium formate - Solvent B: |
| | 100% acetonitrile |
| | Solvent A: 10 mM Ammonium Bicarbonate in water - Solvent B: 10 mM Ammonium |
| | Bicarbonate in 90% MeCN, 10% water |
| Mass Spectrometer | Thermo Q Exactive Orbitrap, Thermo Q Exactive HF hybrid Orbitrap, Leco Pegasus IV |
| Instrument | TOF, Waters Xevo-TQ-S, Thermo Orbitrap Exploris 120 |
| Ionization type | Electrospray Ionization (ESI), Electron Ionization (EI), Heated Electro-Spray Ionization |
| | (HESI) |
| Ionization Polarity | Positive, negative, rapid polarity switching |
| Mass range | 150 Da to 2000 Da |

Data acquisition was performed on sample background matrices including: water, CHO cell lysates, HEK cell lysates, yeast lysates, media, murine plasma, human plasma, equine plasma, human urine, murine tissue, and marine plankton cultured cells. Raw instrument data were converted to mzML format and peak centroiding was performed. Raw data was stored in an external hard drive and processed data was moved to local SSD for machine learning training.

### Example 2: Training a Semantic Foundation Model for Mass Spectrometry

Training a foundation large spectral model (LSM) was performed in a self-supervised manner using randomized masking of spectral features from the raw LC/MS data of Example 1 to generate target sequences for training.

### Data Structure

Each training sample was represented as a sequence of 512 peaks from the mass spectrum. Only peaks with values greater than 50 m/z were selected. The sequence was padded with zeros if the mass spectrum had fewer than 512 peaks and optionally discarded if the mass spectrum had more than 512 peaks. Each value consisted of a triplet that describes a peak by its mass (m/z value), intensity (log₁₀ of the ion count), and ionization mode (encoded as 0 for positive, 1 for negative mode). Each training sample was encoded as a 3×512-dimensional matrix, where the columns represent the peaks in the mass spectrum and the rows represent the values used to describe every peak.

### Encoding

The model architecture consisted of a transformer encoder block and a decoder block. The encoder block architecture consisted of a stack of 8 encoder layers, each with a dimensionality of 128, and 4 attention heads. Positional encoding was performed using dynamic positional bias with linear distances. The encoder block produces a 128-dimensional embedding of the input sequence. The decoder consisted of a multi-layer perceptron (MLP) that predicts the m/z and intensity values of the input mass spectra from the 128-dimensional embedding produced by the encoder block. The MLP outputs a 1,024-dimensional vector that represents a concatenation of the 512 m/z values and 512 intensity values predicted by the model. The MLP includes a Rectified Linear Unit (ReLU) and SoftPlus activation functions.

### Loss Function and Masked Spectral Modeling

The model was trained using a loss function that was the weighted sum of an L1 loss function on the predicted m/z values, and an L1 loss function on the predicted intensity values. The scaling coefficients for these two loss functions were learned during the training process. The L1 loss functions compute the mean absolute error (MAE) between the predicted and true values for the masked peaks. Only the mean absolute errors from the m/z and intensity values that were masked from the target sequences contributed to the L1 loss functions. Target sequences for training the model were generated by masking random peaks from the input sequence. The percentage of peaks to be masked (mask length) varied for each training sample according to a uniform distribution, ranging from 25% to 90% of the total number of peaks.

### Training Hardware and Configuration

Model training was distributed across three NVIDIA RTX A6000 GPUs. The model was trained according to the hyperparameters described in Table 2. Data-parallel training, evaluation, and validation of the model was performed using the DDPSharded strategy.

TABLE 2
Set of hyperparameters used for training.

| Training Hyperparameter | Variations |
|---|---|
| Training optimization algorithm | AdamW |
| Maximum learning rate | 1E−3 |
| Batch size | 256 samples |
| Epochs | 100 |
| Precision | 16 |
| Strategy | Sharded |
| Learning rate scheduler | ReduceLROnPlateau |
| Parameters | factor = 0.2, patience = 25, |
| | min_lr = 1e−8 |
| | One-cycle learning |
| Data-parallel training algorithm | DDPSharded |

### Model Performance

The model was trained for 69 epochs, corresponding to 12.5M global steps. The following metrics were tracked and observed for both the training and validation sets, for both intensity and m/z predictions: mean absolute error (MAE), symmetric mean absolute percentage error (SMAPE), R2, and weighted Loss. Model performance after training is described in Table 3. The mean absolute error of the m/z value predictions over training was not asymptotical as of 69 epochs of training, which indicates that the model still has the capacity to learn and improve performance.

TABLE 3
performance of observed metrics during
training and validation of the model

| Training | Performance for | Performance for |
|---|---|---|
| metric | intensity predictions | m/z predictions |
| R2 | 0.36 on training set | 0.99 on training set |
| | 0.35 on validation set | 0.99 on validation set |
| MAE | 0.040 on training set | 1.64 on training set |
| | 0.041 on validation set | 1.69 on validation set |
| SMAPE | 0.085 on training set | 0.0065 on training set |
| | 0.086 on validation set | 0.0072 on validation set |
| Loss | 0.041 on training set | 0.0016 on training set |
| | 0.041 on validation set | 0.0017 on validation set |

### Example 3: LSM Embedding and Fine-Tuning for Predictive Modeling of a Clinical Dataset

### Dataset Description

The LSM foundation model of Example 2 was fine-tuned using annotated raw high-resolution LC/MS data [Luan et al., J. Proteome Res., 13, 1527-1536 (2014) https://doi.org/10.1021/pr401068k, and archived data from the MetaboLights database (EMBL-EBI, Cambridge, UK)].

The annotated dataset contained blood plasma samples obtained from 180 pregnant women recruited from the Maternity and Child Health Hospital of Shenzhen China. The data were collected using a Shimadzu Prominence HPLC, coupled to a Thermo Scientific LTQ Orbitrap Velos instrument, using a C18 column (3.5 μm, 2.1 mm×150 mm; Agilent Technologies), in both positive and negative ionization modes. The mass scanning range was 50 1,500 m/z, with a resolution of 30,000 at (n/z 400). The LC-MS was run in binary gradient mode, with Solvent A 0.1% (v/v) formic acid/water, and solvent B was 0.1% (v/v) formic acid/methanol. The flow rate was set to 0.200 mL/min. The LC-MS run had a duration of 20 minutes.

### Model Architecture and Fine-Tuning

For running inference, the model architecture consisted of the encoder block as described and trained in Example 2, followed by a decoder block composed of a Linear Discriminant Analysis model (LDA). The LDA model was trained on the dataset to classify samples by assigning probabilities to three classes (Class 0, Class 1, and Class 2) corresponding to pregnancy duration measured in trimesters. The samples were processed as follows in preparation for use in fine-tuning the LDA model of the decoder block Embeddings were generated for every mass spectrum of every sample in the dataset using the model encoder block trained in Example 2. The embeddings in a given sample were averaged across all the mass spectra so as to produce a 128-dimensional time-averaged embedding. These time-averaged embeddings were used as inputs to train the LDA model. The LDA was trained using an 80/20 train/test data split over 10 cross-validation folds. The best model was selected according to the highest F1 score after 100 iterations of hyperparameter optimization.

### Model Performance

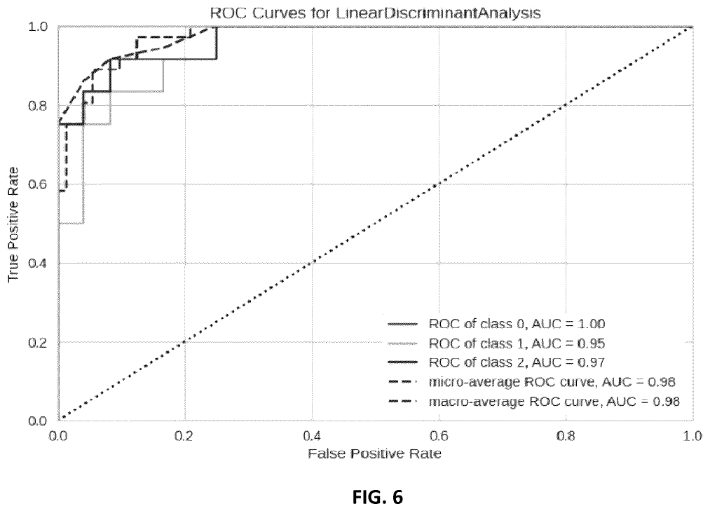

The Receiver Operator Curves (ROC) and corresponding Areas Under the Curve (AUC) were computed as shown in FIG. 6. The AUC for Class 0 was determined to be 1.00. The AUC for Class 1 was determined to be 0.95. The AUC for Class 2 was determined to be 0.97. As illustrated in FIG. 6, the micro-average and macro-average ROC curves were both determined to have an AUC of 0.98 and P<0.05, indicating statistically significant prediction.

### Example 4: Comparative Example

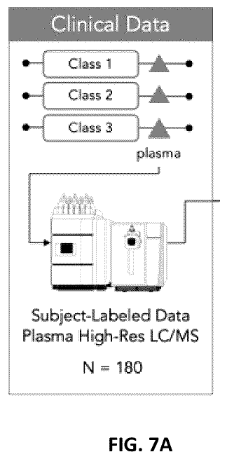

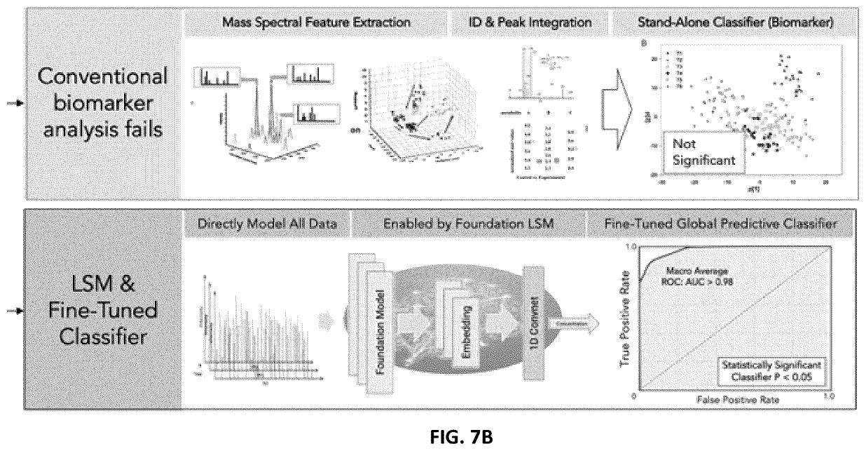

Conventional metabolomic analysis for the purpose of biomarker identification was found to be unable to assign study participants to their diagnostic class based on their blood metabolome using stand-alone predictive modeling via principal component analysis and clustering [Luan et al., J. Proteome Res., 13, 1527-1536 (2014) https://doi.org/10.1021/pr401068k], as illustrated in FIG. 7B, comparing to current application; while both were input data from subject-labeled data of plasma high-res LC/MS from FIG. 7A.

### Example 5: Vector Search on a Human Plasma Clinical Data Set

Vector search based on the whole plasma metabolome of the clinical study participants of Example 3 was implemented using the 128-dimensional embeddings generated from the LSM foundation model of Example 2. Each study subject was characterized by its vector embedding as a representation of its encoded plasma metabolome.

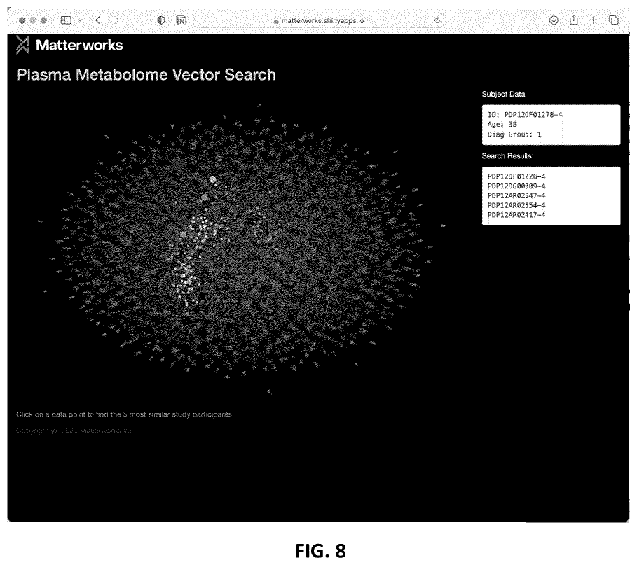

Vector search to identify study participants most similar to a target subject was implemented by computing the cosine similarity of the target subject with each of the other study participants. The study participants were ranked in order of decreasing cosine similarly. As illustrated in FIG. 8, a web application was implemented in R Shiny to provide graphical representation of each study participant was obtained by computing a 2-dimensional Uniform Manifold and Projection (UMAP) projection of their 128-dimensional vector embedding, and plotting the participant as a selectable point in the web app. Study participants points were assigned a color based on their study classification and overlayed on a background plot reflecting the UMAP coordinates for the underlying LSM training set.

A target participant could be selected by clicking on their associated point or by entering their study subject ID into a search bar, as shown in FIG. &. The application implemented the vector search and marked the five most similar other study participants by highlighting their respective plotted points and outputting their study subject IDs to a search result text field in the app.

### Example 6: Application Cases of Cell and Gene Therapy

The application of human pluripotent stem cells (hPSCs; including embryonic and induced; hESC and hiPSC) ranges from advanced drug discovery assays, to in vitro diseases models, and ultimately regenerative therapies [https://stemcellsjournals.onlinelibrary.wiley.com/doi/full/10.1002/setm.20-0453]. The development of cell therapies will require a large number of cells. Cell therapies for solid organs such as the heart, pancreas, liver or brain require 10⁸ to 10⁹ cells per patient [https://pubmed.nebi.nlnm.nih.gov/23531528/] For hPSC-derived blood cells such as macrophages [https://www.nature.com/articles/s41467-018-07570-7] and erythrocytes [https://journals.plos.org/plosone/article?id=10.1371/joumal.pone.0166657] even higher numbers ranging beyond 10¹¹ cells per patient are discussed. However, meeting such demands requires robust, efficient, and economically viable hSPC production processes ultimately compliant with clinical and regulatory standards.

Although the field of hPSCs bioprocessing has seen improvements, reaching up to 0.5×10⁶ hPSCs/mL in 100 mL culture scale, it still lags behind the cell densities of 100×10⁶ cells/mL reported in CHO bioprocessing. In silico prediction and modulation of process parameters and feeding strategies in order to optimize the bioprocess according to the dynamic requirements of cells throughout the culture process [https://pubmed.nebi.nlm.nih.gov/27369897/] and [https://pubmed.nebi.nlm.nih.gov/27977910/]

Prediction of viable cell density in ranges 1×10⁵ cells/mL to 1×10⁸ cells/mL from days 1, 2, 3, 4, 5, 6, and 7 of culture based on the raw mass spectrometric data obtained from the cell culture of hematopoietic stem cells, mesenchymal stem cells, neural stem cells, epithelial stem cells, skin stem cells, embryonic stem cells, or induced pluripotent stem cells.

Prediction of aggregate size in ranges with mean aggregate diameter ranging from 10-300 μm, ranging from 1×10¹ cells/aggregate to 1×10³ cells/aggregate, from days 1, 2, 3, 4, 5, 6, and 7 based on the raw mass spectrometric data obtained from the cell culture hematopoietic stem cells, mesenchymal stem cells, neural stem cells, epithelial stem cells, skin stem cells, embryonic stem cells, or induced pluripotent stem cells.

Prediction of stem cell content ranging from 10-90%, based on pluripotency surface markers from days 1, 2, 3, 4, 5, 6, and 7 based on the raw mass spectrometric data obtained from the cell culture hematopoietic stem cells, mesenchymal stem cells, neural stem cells, epithelial stem cells, skin stem cells, embryonic stem cells, or induced pluripotent stem cells.

Adaptive process control of stem cell culture by an artificial intelligence agent. The agent sets process parameters such as temperature, pH, DO, CO₂, and stirring rate, or determines the feeding strategy through the addition of specific ingredients to the media such as amino acids and growth factors. The agent sets these parameters and feeding strategy based on a readout of bioreactor sensors (temperature, CO₂, DO, pH), and/or the raw mass spectrometric readout of either the cell culture lysate, supernatant, or both. The mass spectrometric readout can be done either in-line, at-line, or off-line. The agent performs an adaptive process control strategy that optimizes critical quality attributes such as viable cell density, cell aggregate size, markers of pluripotency, maintenance of the unrestricted differentiation potential, and karyotype stability.

### Example 7: Improved Spectral Lookup and/or Molecular Property Classification Using an Example Large Structural Model (LSM)

As a concrete demonstration, the self-supervised training of an MS2LSM, a Large Spectral Model (LSM) built for MS2, a representative of an overall foundation models for primary—omic data, is described. The MS2LSM was fine-tuned on the specific task of chemical property prediction, and its performance was compared to recent highly-successful stand-alone DL models for chemical property prediction [Voronov et al., 2022a,b].

Like the standalone DL model results, the fine-tuned predictive model outperforms property prediction obtained by spectral similarity searching of large reference databases, i.e., spectral look-up methods. Separately, it was demonstrated that MS2LSM outperforms both a supervised transformer architecture and a heuristic-based method (cosine similarity) in the more conventional spectral lookup tasks.

### Dataset Preparation

An initial dataset comprising a total of 9,900,602 MS/MS spectra was assembled, drawing from a combination of internally acquired and extracted spectra from well-known databases. Of the approximately 9.9 million spectra, 8,620,419 spectra were unlabeled, meaning they have no paired structural and identity annotations. Of the approximately 9.9 million total spectra, 1,282,758 spectra were at least partially labeled. Filtering to exclude any spectra missing sufficient identity information and to exclude any spectra whose precursor molecular mass was above 1000 m/z, results in a total of 790,713 labeled spectra From the molecular identity of these labeled spectra, the 790,713 spectra were further annotated with 209 chemical property descriptors obtained via the RDKit package. After this initial dataset preparation, the datasets were curated similarly to the procedures described in Voronov et al. [2022a]; Huber et al. [2021b].

For evaluation, 3 separate datasets were created to mimic common metabolomics workflows. The first dataset was an “unknown” dataset, which was both spectral disjoint and molecular disjoint, meaning the molecules in this dataset were not present at all in the training dataset. This dataset comprises of 12,285 spectra and 2,026 different molecules. Most molecules in the dataset have more than one spectrum due to different collision energy, modes, and appearing in multiple databanks. Molecule disjointedness was ensured via making this split on the first 14 keys of the InChiKey. This dataset was analogous to performing analysis on a completely unseen set of data.

The next dataset was a “known” dataset, which consists of 1,000 spectra randomly sampled from the dataset. This dataset was spectra disjoint, meaning the spectra themselves were not in the training dataset, however it was not molecular disjoint. This “known” dataset mimics an experiment where the set of possible molecules analyzed were known, but distributions may be different to the test set. The third dataset was the Critical Assessment of Small Molecule Identification (CASMI) 2022 dataset, which was used as a “challenge” dataset Extraction of 493 of the 500 CASMI 2022 molecules was achieved. For model development and validation, “known”, “novel”, and the CASMI 2017 datasets were prepared in the same manner. While pre-processing, it was ensured that none of the CASMI 2022 dataset was present in the training dataset to prevent leakage.

### Spectrum Tokenization

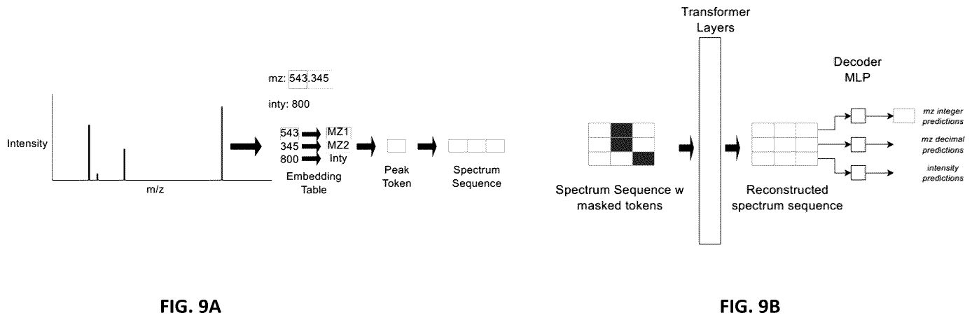

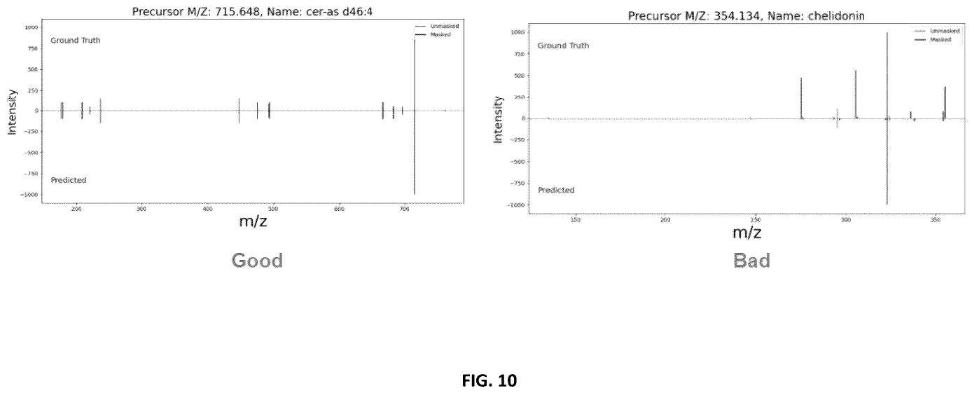

A key component of the example model was the tokenization strategy for MS data. Given the continuous large range of m/z and intensity of Mass-Spec peaks, common tokenization strategies in NLP and Computer Vision struggle to properly encode MS spectra. Prior papers approach the tokenization of MS spectrathrough binning [Huber et al., 2021b], sinusoidal position embedding [Voronov et al., 2022b], and a codebook for integer (nominal mass) and decimal (mass defect) parts of m/z and intensity values [Butler et al., 2023]. The last of these tokenization strategies, depicted in FIG. 9A, was chosen to be adopted Spectra were first sorted by m/z and peaks over 1000 m/z were pruned. Then for each peak in a spectrum, the integer and decimal parts of each m/z peak were separately embedded using a learnable codebook. Furthermore, a codebook was used to embed the intensity values of the peaks, which were scaled to a maximum of 1000. Finally, for each peak, the integer m/z embedding, decimal m/z embedding, and intensity embedding were concatenated, and this concatenated embedding vector was passed through a single linear layer to create a peak token. Each spectrum was represented by a sequence of these tokens corresponding to its peaks. Furthermore, a special precursor token was prepended to the beginning of every spectrum token sequence. The precursor token was generated similarly to other peak tokens. However, all precursors have a preset intensity value of 2000.

### Pre-Training

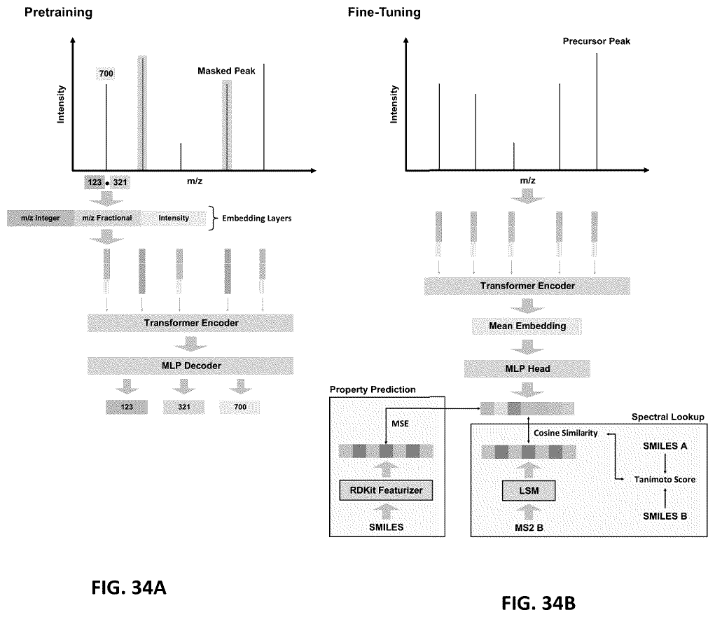

The strength and value of the method lie in the pre-training. Pre-training primes models with contextual information for downstream fine-tuning tasks, empirically improving performance compared to supervised-training only methods. Pre-training can be performed using any method described herein, for example, as illustrated in FIG. 9B or 34A The pre-training was approached in a reconstruction-based masked-signal-modelling approach as described in FIG. 9B. Input spectra were tokenized and if any of the spectra had fewer than 64 peaks, the sequence was also padded to reach 64. Then, 25% of peaks were randomly masked with a learned mask token. This partially masked token sequence was passed through transformer layers. Finally, each token in the transformer output was passed through three heads, which predict an integer m/z, decimal m/z, and intensity value. The cross-entropy loss between the predicted and ground-truth for all non-pad peak integer m/z, decimal m/z, and intensity values were aggregated into the final pre-training loss function described in equation 1 below:

$${L}_{final} = ii : {L}_{mzI} + \{ 3 : {L}_{mzD} + y : {L}_{Int} \qquad Equation ( 1 )$$

LmzI, LmzD, and LInt were the integer m/z, decimal m/z, and intensity losses respectively. Furthermore a, B, and y were weights applied to the parts of the loss function. “A=100, B=1, y=1 were set respectively. Finally, for all fine-tuning tasks, the pre-training model checkpoint with the lowest total loss, (Lfinal), on the unseen molecule validation dataset was used.

TABLE 4
MAE results of pre-training on the three evaluation datasets.
MAE for Intensity and m/z, for both masked and unmasked tokens
are reported. Intensity ranges for all spectra were 0-1000.

| | MAE | MAE Intensity | MAE | MAE MZ |
|---|---|---|---|---|
| | Intensity | (Masked) | MZ | (Masked) |
| Unknown | 25.5 | 119.3 | 1.53 | 6.46 |
| Known | 29.4 | 120.1 | 1.32 | 5.22 |
| CASMI 2022 | 29.9 | 115.5 | 1.99 | 8.22 |

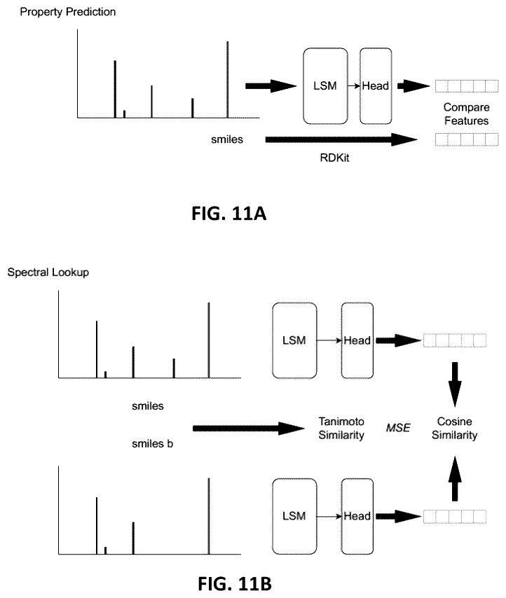

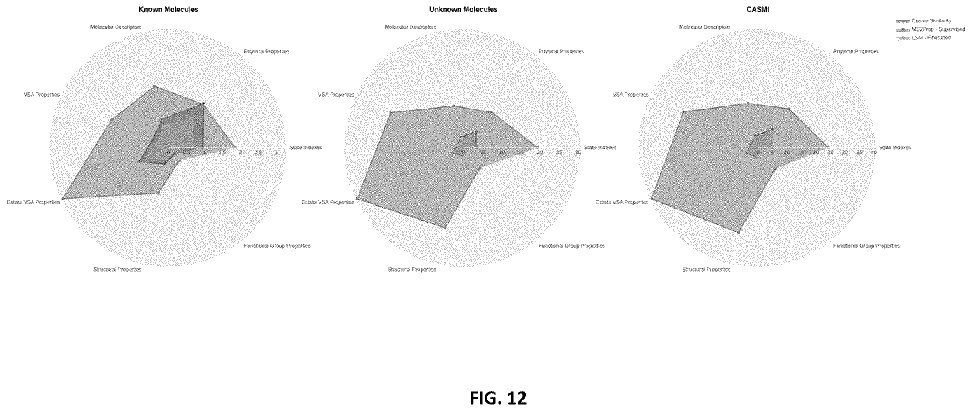

Table 4 reports pre-training mean absolute error (MAE) and accuracy for both intensity and mz. These results indicate that the pre-training model was able to moderately reconstruct masked MS2 peaks. Thus, it can be inferred that the pre-trained model captured some degree of the semantics of MS2. FIGS. 11A-B provide a good indication that the model effectively learned the MS2 modality. With sufficient unmasked peaks, such as in FIG. 11A, the model was able to effectively reconstruct the masked peaks. The opposite was true in FIG. 11B, where most key peaks were masked, thus giving the model insufficient information, leading to very poor reconstruction predictions.

### Chemical Property Prediction

Chemical property prediction directly from mass spectral data has seen recent advances, such as the application of fully-supervised, transformer-based models [Vaswani et al., 2017; Voronov et al., 2022a] to analyze input spectra. Generally, these property prediction models begin by embedding a spectrum into a tokenized format, then passing this spectrum through attention layers to yield a series of property predictions. DL-based library spectral lookup techniques, on the other hand, involve the comparison of two annotated spectra from the dataset. These spectra were embedded into a latent space and trained to minimize the Tanimoto similarity of the respective compounds they represent[Huber et al., 2021b; Guo et al., 2023; Goldman et al., 2023]. From here, database retrieval can be performed on the most similar embedding to a given query molecule.

### Base Case Methods for Chemical Property Prediction

For property prediction, three baseline methods were used, a re-implementation of MS2Prop, a supervised-only version of the LSM model, and modified cosine similarity. In the reimplementation of MS2Prop, an MS2Prop model was trained using hyperparameters and token embedding strategy according to embodiments described herein. Namely, the transformer backbone uses 32 heads, 6 layers, a hidden dimension of 512, and no positional encoding. Furthermore, MS/MS peaks were embedded into tokens as follows. Peak m/z values were first rounded to the nearest 0.1, then these values were fed through a learnable lookup table, then the intensity value (normalized to 1.0 for non-precursor tokens and 2.0 for precursor tokens) is concatenated to the m/z embedding, and finally, this concatenated token vector was passed through a linear-layer of depth 1 to project it to the hidden dimension Voronov et al. [2022a].

The first token in the sequence was used as a classification token. It is worth noting that this re-implementation of MS2Prop has at least 3 key differences from the Voronov et al. [2022a], the training dataset, training hyper-parameters (batch size, learning rate, number of epochs), and the number of outputs (209 properties were predicted instead of 10). Given that the MS2Prop paper does not indicate what learning rate or number of epochs is used, a learning rate of 0.00025 for 50 epochs was used. This learning rate was selected after performing a learning rate grid-search to minimize MAE in the unknown validation dataset. For the supervised-only baseline model, the same hyper-parameters as in the fine-tuned LSM were used.

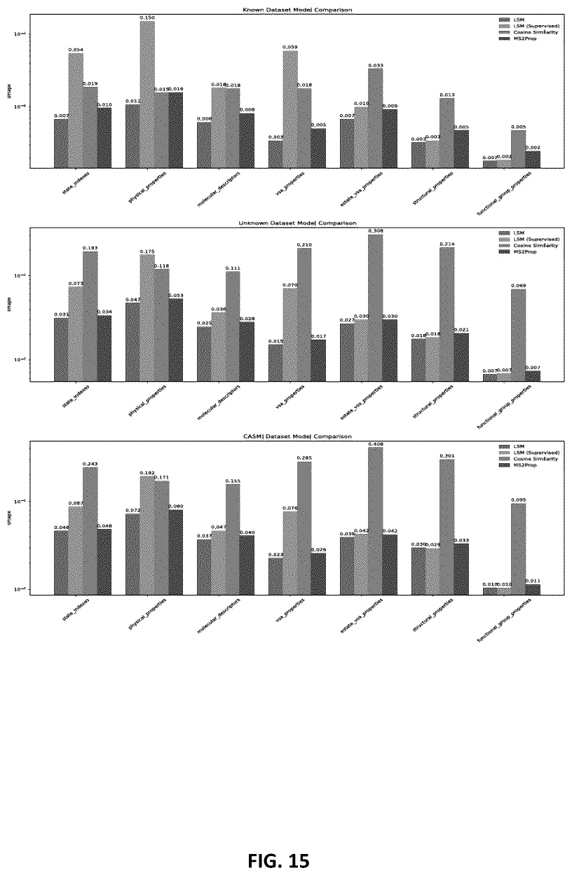

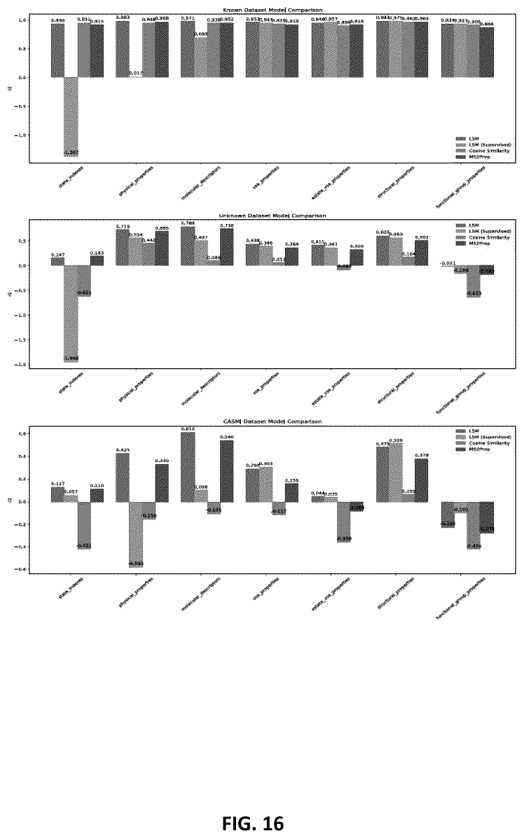

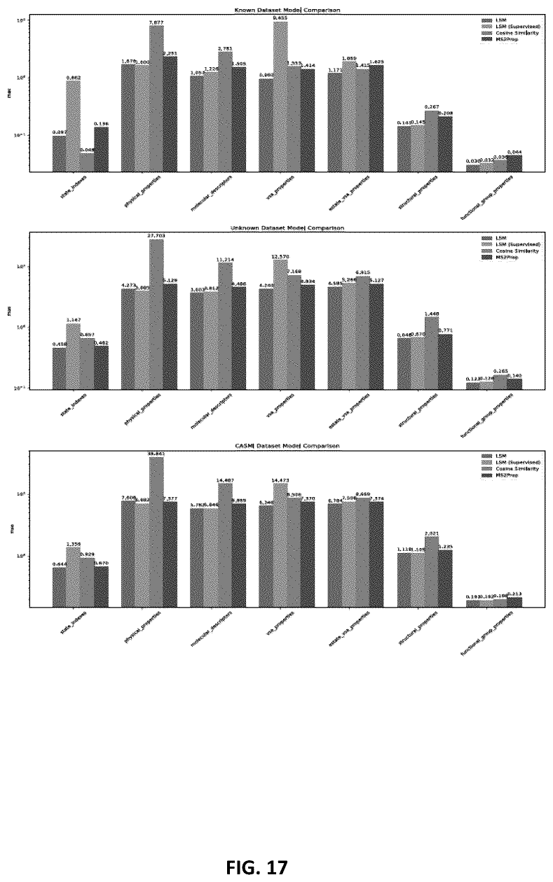

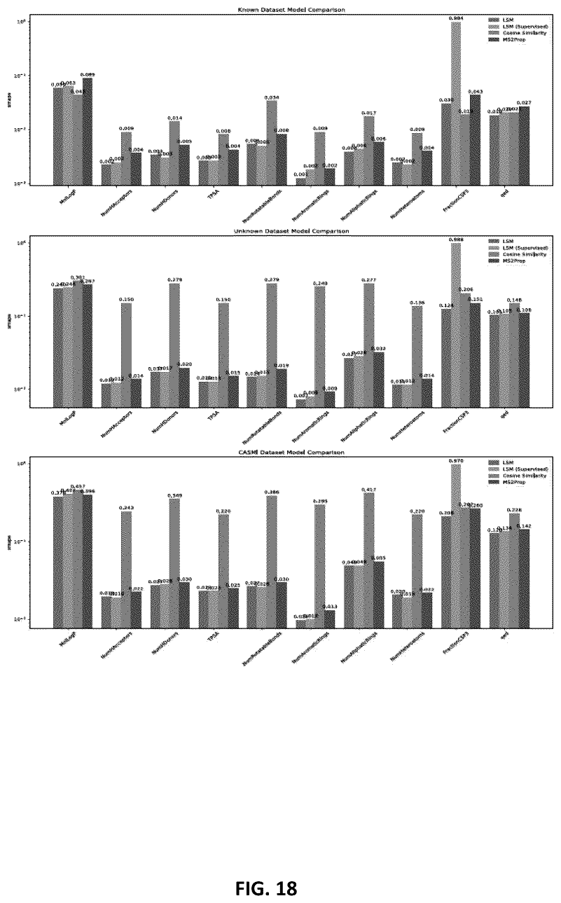

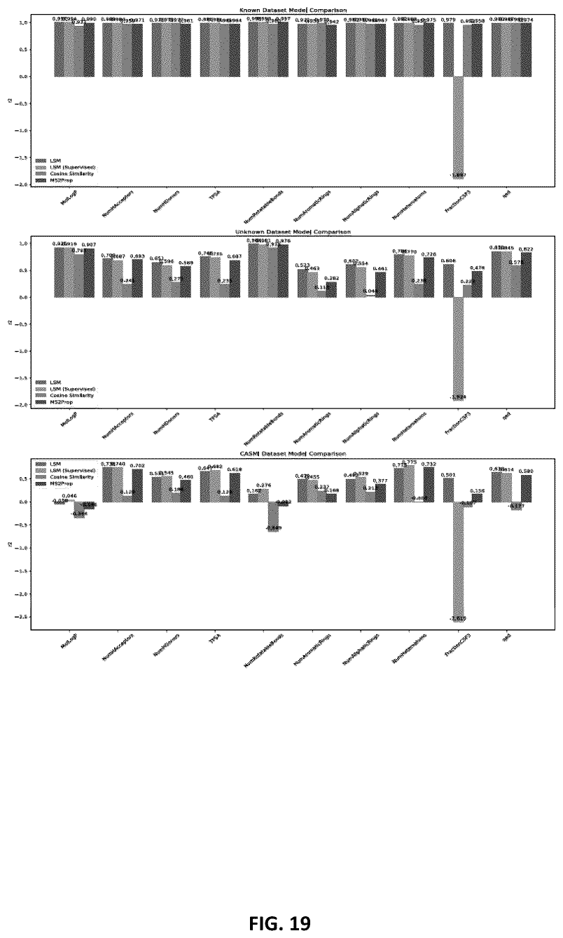

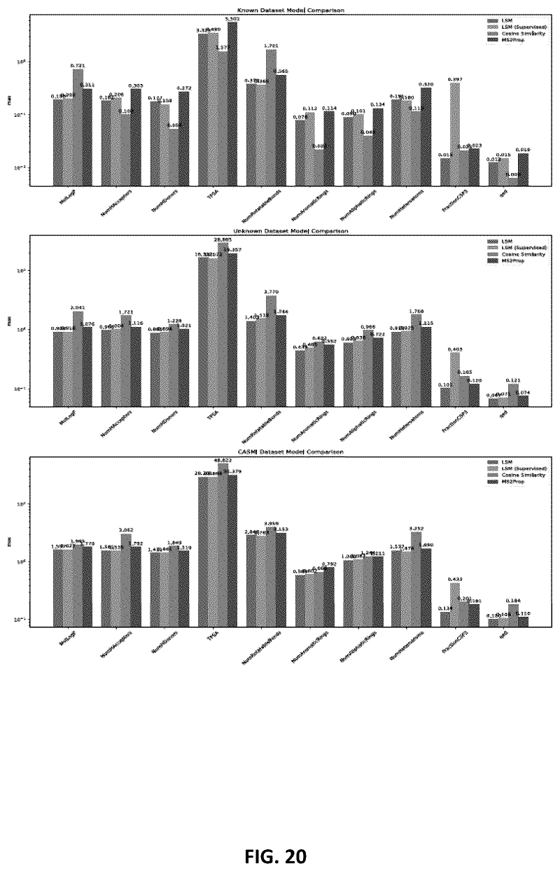

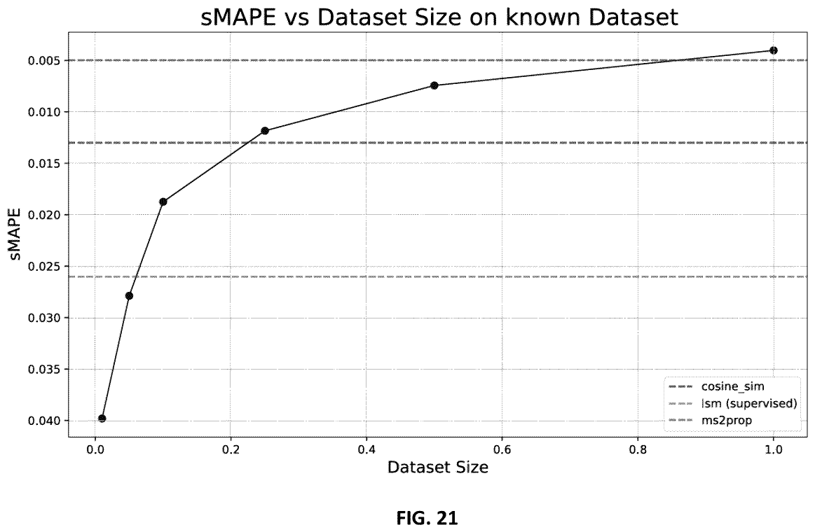

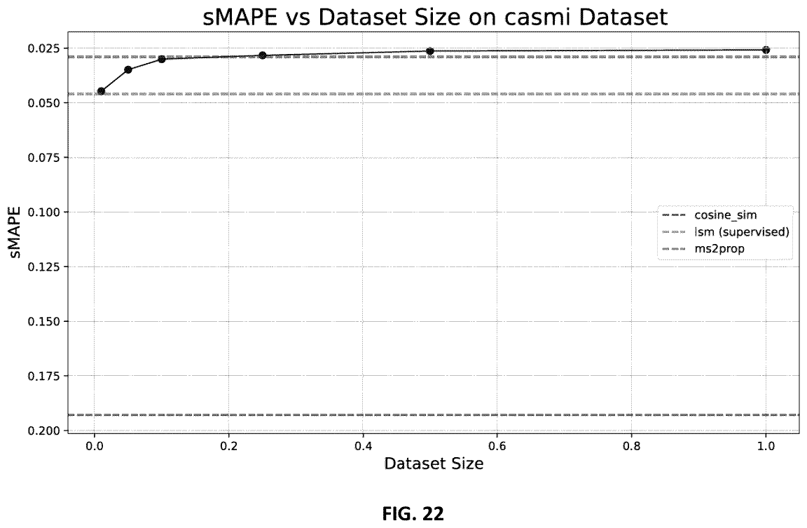

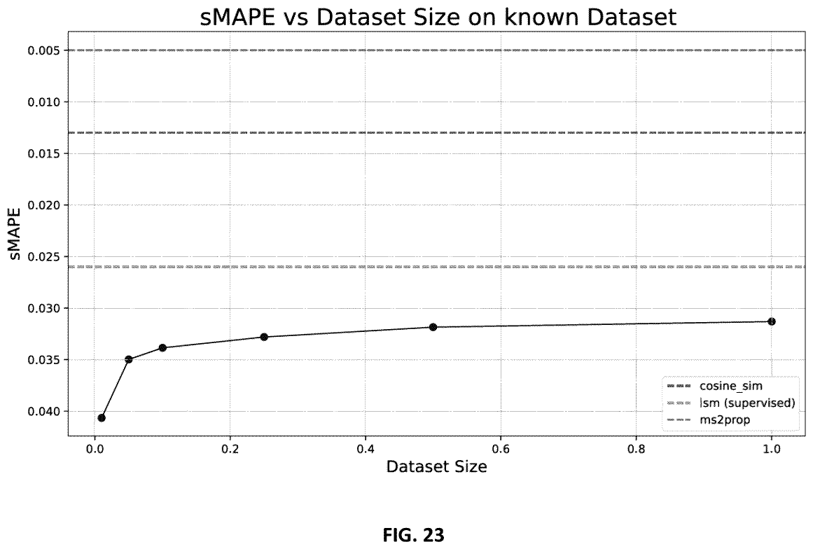

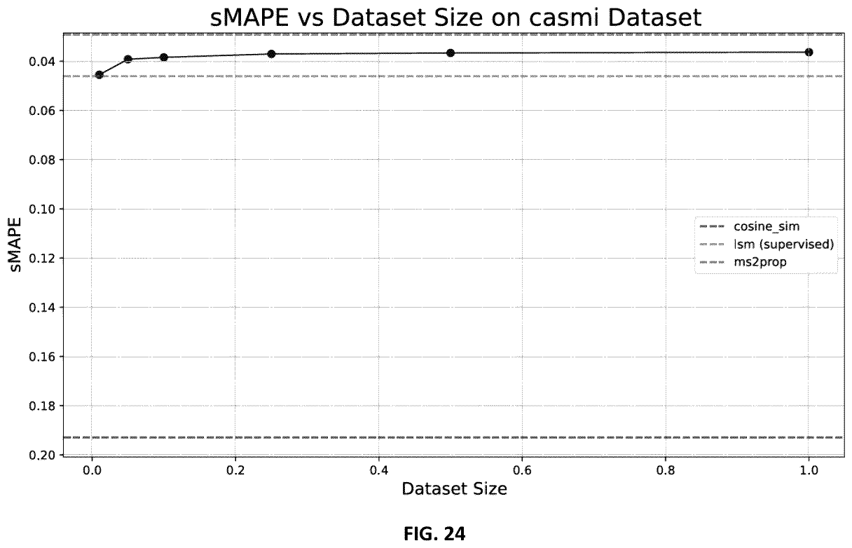

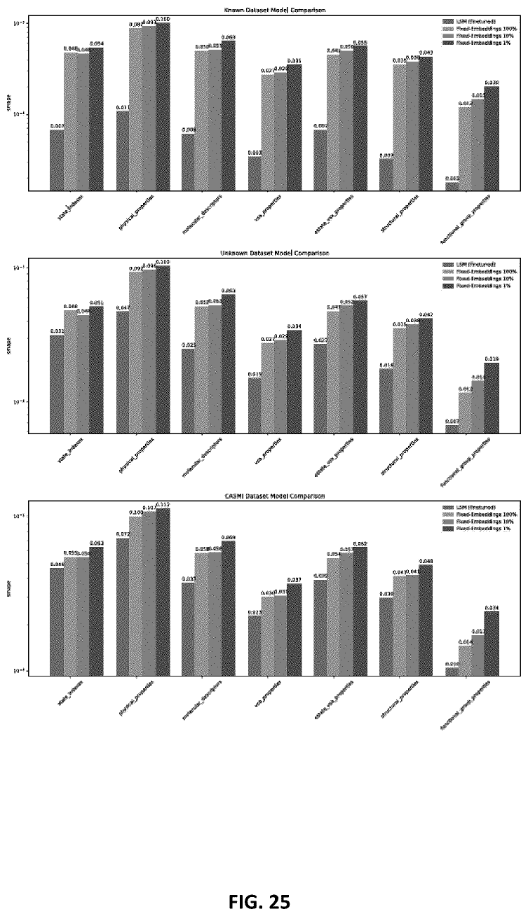

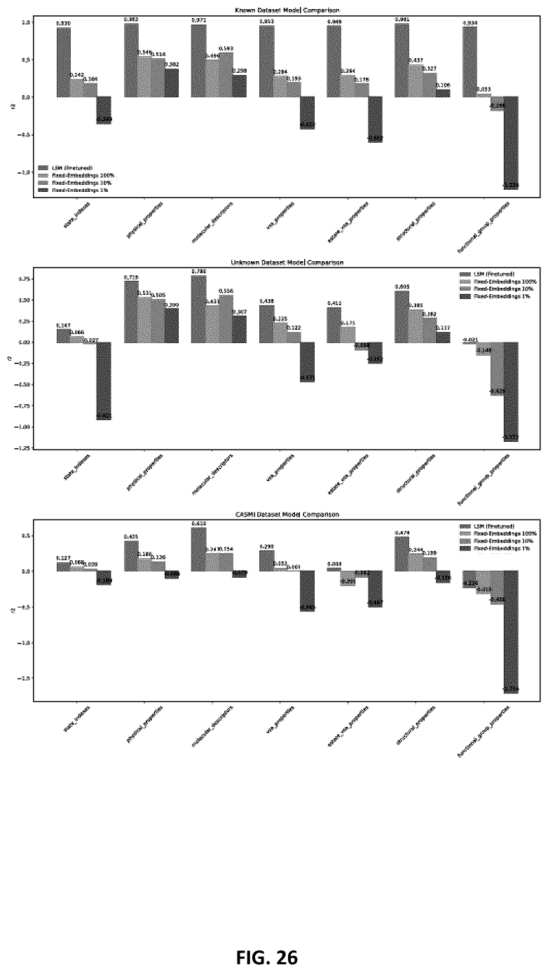

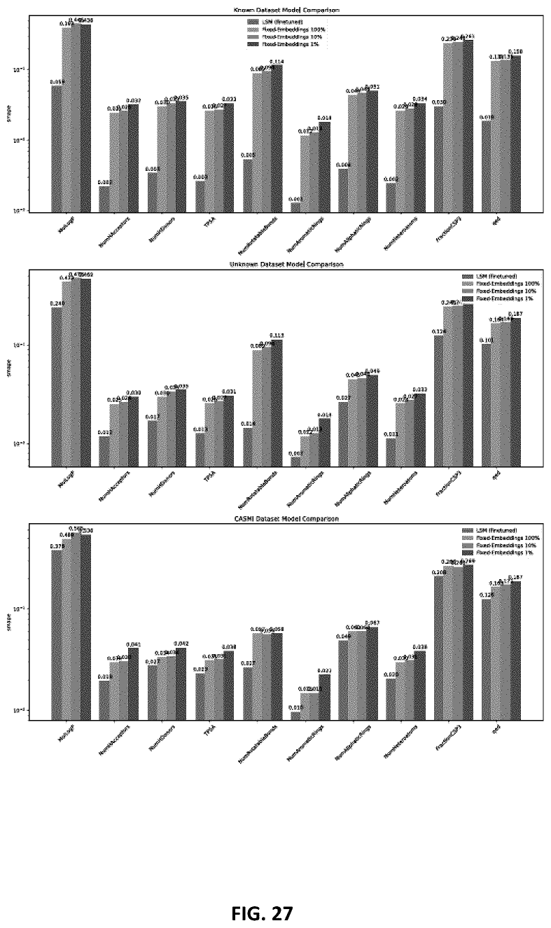

Finally, to evaluate the cosine similarity baseline, the most similar spectrum in the training dataset for every query spectrum in the test dataset was retrieved. Then, the query's molecular properties were imputed with the properties of the retrieved molecule. In the results, only best-in-class performance is reported Thus, given that the MS2Prop and supervised-only LSMs were similar supervised-only transformer architectures, only the top-performing representation (MS2Prop) is reported. Performance on all methods is reported in FIGS. 15-30.

### Fine-Tuning

To fine-tune the model for property prediction, the architecture of FIGS. 11A-11B was adopted. Given a SMILES-labeled spectrum, this spectrum was passed through the pre-trained LSM to generate an output spectrum embedding. The mean of all of these token values (including the precursor) was computed, and this resultant embedding was passed through a single linear-layer classification head, which outputs a vector of size 209, the number of properties to be predicted. These predicted properties were then compared to the ground-truth properties vector computed by RDKit on the SMILES identifier of the MS/MS spectrum. Each property in this ground-truth vector was normalized between 0 and 1 to ensure that the model does not overfit to certain properties. The loss for this fine-tuning task was calculated via the Mean Square Error (MSE) of these two resultant vectors.

### Spectral Lookup

### Base Case Comparison for Spectral Similarity Searching

Most current approaches to MS/MS analysis rely on spectral lookup within annotated MS/MS spectra databases. Query spectra were matched against annotated spectra in databases using heuristic algorithms to find close molecular matches, which then serve to identify the query molecules. One such heuristic algorithm is known as modified cosine similarity. Modified cosine similarity aligns the peaks of a query spectrum with the peaks of reference spectra based on a Dalton value threshold Subsequently, the cosine similarity of the aligned peaks' intensities was calculated, with the most similar reference spectrum—and thus the identified molecule—being returned as the output [Watrous et al., 2012; Wang et al., 2016].

### Fine Tuning

The LSM was fine-tuned for spectral lookup as portrayed in FIG. 11A and FIG. 11B. Similarly, fine-tuning can be accomplished by any method described herein, for example, using the workflow illustrated in FIG. 34B. The inputs were two SMILES-labeled spectra. Each of these spectra was passed through the LSM, generating two spectrum embeddings. Then the mean of all of the tokens was taken, and the resulting vector was passed through a single linear-layer head, which creates a dimensionally smaller “molecular” embedding. Finally, the cosine similarity of the two “molecular” embeddings was calculated. The loss of this fine-tuning task was calculated by taking the mean-square error of the predicted cosine similarity versus the ground-truth Tanimoto similarity. Ground-truth similarity was calculated using RDKit with 2048 bit Morgan fingerprints and a maximum atomic radius of 2.

Spectral lookup was evaluated on two tasks: a Tanimoto prediction task and a database retrieval task. The predictive accuracy of the fine-tuned spectral-lookup model in estimating Tanimoto scores was assessed through the generation of all-for-all molecular similarity prediction matrices for each evaluation dataset. These matrices were compared to the ground-truth Tanimoto similarity matrices to determine the performance of the model in predicting molecular similarity. The evaluation of spectral lookup also involves the creation of a spectral database with the training set. For each spectrum in the evaluation datasets, the most similar spectrum in the training dataset was retrieved. The percentage of retrievals which were close molecular matches, i.e., Tanimoto similarity >0.6, and extremely close molecular matches, i.e., Tanimoto similarity >0.95, were then computed. The most similar spectrum in the dataset was retrieved as follows. For each query spectrum's molecular embedding the cosine similarity of this embedding to all the molecular embeddings in the training set was found. The training set search space was then narrowed down to a threshold of the query's precursor mass, since the precursor mass was always known for MS2. Finally, the molecule in the precursor-filtered training dataset with the highest cosine similarity to the query was returned.

Two baseline methods for spectral lookup were used: modified cosine similarity and MS2Deepscore. To evaluate modified cosine similarity on Tanimoto estimation, the modified cosine similarity score was used as the predictions. For cosine similarity evaluation for spectral lookup, the similarity of the query to all spectra in the training dataset was evaluated, returning the most similar training molecule. For both of these tasks, a modified cosine similarity m/z tolerance of 0.005 was used. To evaluate MS2Deepscore, a pre-trained model from github.com/matchms/ms2deepscore was used.

### Results

### Property Prediction

TABLE 5
Evaluation Metrics Property Prediction across Datasets

| | | |
|---|---|---|
| Mean Unknown | Mean Known | Mean CASMI |

Modified Cosine

| | | | |
|---|---|---|---|
| R² | −0.186 | 0.922 | −0.257 |
| MAE | 5.70 | 1.400 | 7.519 |
| SMAPE | 0.141 | 0.013 | 0.193 |

MS2Prop Re-Implementation (Supervised-only)

| | | | |
|---|---|---|---|
| R² | 0.253 | 0.911 | 0.069 |
| MAE | 2.524 | 0.828 | 3.756 |
| SMAPE | 0.019 | 0.005 | 0.0285 |

MS2LSM (Fine-Tuned)

| | | | |
|---|---|---|---|
| R² | 0.356 | 0.952 | 0.153 |
| MAE | 2.140 | 0.583 | 3.351 |
| SMAPE | 0.017 | 0.004 | 0.026 |

Table 5 presents the property prediction results across all 209 properties. It was observed that across all three datasets and all three metrics, the fine-tuned MS2LSM outperforms both the MS2Prop re-implementation and cosine similarity. It was also noted Chat the known dataset was the dataset with the most similar performance between all three methods, which generally all perform well.

The identified results on the aggregate scores of different molecular property categories, as listed, are presented in FIG. 12. The following categories of features were used: state indexes, physical properties, molecular descriptors, VSA properties, EState VSA Properties, structural properties, and functional group properties. A difference was observed across all categories and datasets, with the fine-tuned LSM consistently outperforming other methods. This difference was especially pronounced in the unknown molecules and CASMI datasets. Additionally, it was observed that for the known dataset, the model exhibits near-perfect performance on property predictions in all of the categories, scoring a sMAPE of 1.25% or less on all categories. Furthermore, in the unknown and CASMI dataset, a sMAPE of less than 50 and 7.25 respectively on all categories was reported.

TABLE 6
Dataset Evaluation Metrics

| | | |
|---|---|---|
| Unknown | Known | CASMI |

Modified Cosine

| | | | |
|---|---|---|---|
| RMSE | 0.208 | 0.182 | 0.154 |
| MAE | 0.140 | 0.125 | 0.116 |
| Useful Match (%) | 0.38 | 0.96 | 0.11 |
| Close Match (%) | 0.19 | 0.82 | 0.00 |

MS2Deepscore

| | | | |
|---|---|---|---|
| RMSE | 0.274 | 0.276 | 0.267 |
| MAE | 0.235 | 0.241 | 0.253 |
| Useful Match (%) | — | — | — |
| Close Match (%) | — | — | — |

MS2LSM

| | | | |
|---|---|---|---|
| RMSE | 0.215 | 0.198 | 0.101 |
| MAE | 0.122 | 0.116 | 0.071 |
| Useful Match (%) | 0.37 | 0.97 | 0.05 |
| Close Match (%) | 0.22 | 0.91 | 0.00 |

The spectral lookup results for the Tanimoto similarity prediction task are presented in Table 6. For both RMSE and MAE on all three datasets, superior performance was achieved by MS2LSM compared to MS2Deepscore. Additionally, for the CASMI 2022 dataset, MS2LSM outperforms cosine similarity. For the unknown and known datasets, MS2LSM outperforms cosine similarity on MAE, and the RMSE was comparable. The spectral lookup results on the database retrieval task are also reported in Table 6. For all three datasets, MS2LSM achieves similar to superior performance in both finding “close matches” (Tanimoto 2′ 0.95) in the reference spectral database. Similar performance to modified cosine lookup was also achieved in finding “useful matches” (Tanimoto 2′ 0.6).

Finally, it's worth mentioning that even though modified cosine had similar results for many of the metrics on this task, MS2LSM was still considered the superior method due to its speed. For the Tanimoto similarity score, the results took about 3 hours to generate using modified cosine and 40 s to generate using MS2LSM. Furthermore, for the spectral lookup task, after a one-time 1 hr investment to generate a training embedding store, MS2LSM took 1 min to evaluate spectral lookup. In contrast, modified cosine took over 60 hours to generate its results. Thus, this significant increase in speed renders MS2LSM much more scalable, agile, and useful for large quantities of data.

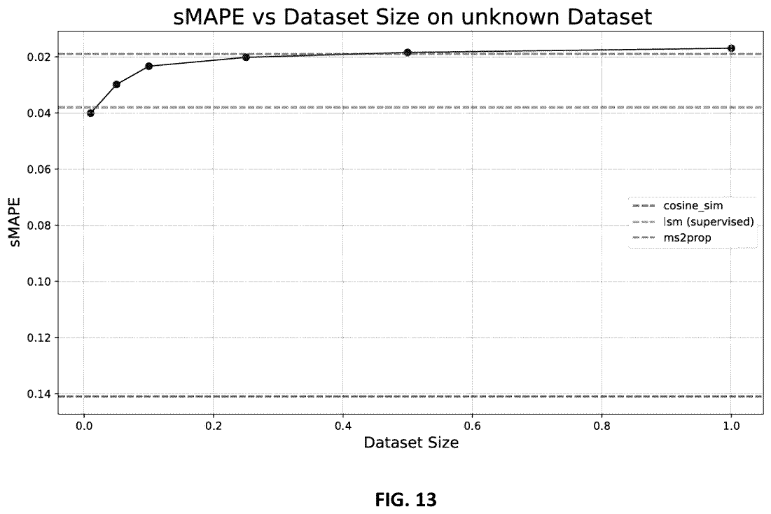

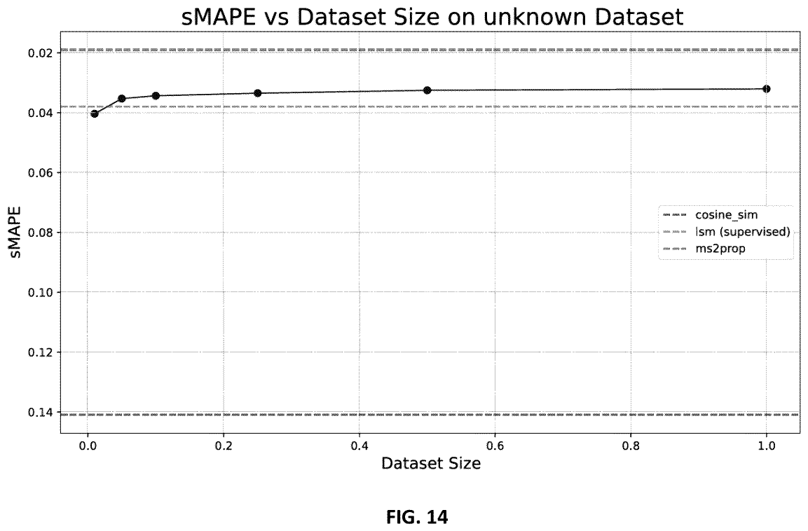

One of the key benefits of this self-supervised approach was that it requires less fine-tuning data for downstream tasks. This benefit was demonstrated in FIG. 13. In this figure, dataset size was evaluated against downstream performance on the unknown dataset for a property prediction task. The pre-trained LSM was fine-tuned using 1, 5, 10, 25, and 50% of annotated training data respectively. Through fine-tuning on just 1% of the data, cosine similarity performance was significantly surpassed, and similar performance to the supervised-only LSM was achieved. Furthermore, with just 25-50% of the annotated training data, better performance than the ms2prop re-implementation was attained, which not only uses more training data but also employs a different tokenization strategy. Given these results, it's anticipated that a major benefit of this method was smaller fine-tuning datasets for future tasks. Smaller fine-tuning datasets, in turn, indicate that the model was agile and can easily be adjusted.

TABLE 7
Comparison of Dataset Size to Training Time

| Dataset Size | Training Time (minutes) |
|---|---|
| 0.01 | 29.37 |
| 0.05 | 85.07 |
| 0.10 | 139.51 |
| 0.25 | 329.85 |
| 0.50 | 633.06 |
| 1.00 | 1269.00 |

Less fine-tuning data also entails faster training times. Training speeds for various dataset sizes are shown in Table 7. All these models used a batch size of 512 and A100 GPU. Given the aforementioned strong performance of the model trained on just 1% of the dataset, strong performance on property prediction was achievable with under 30 minutes of training time.

In this disclosure, empirical evidence is presented highlighting the advantages of self-supervised learning for Mass Spectrometry applications. Property-prediction results are reported using fixed embeddings from the pre-trained encoder. This task serves as a robust metric to gauge the efficacy of embeddings generated by foundational models in this machine learning paradigm. In this case, results on this task were reported by training a one-layer multi-layer-perception prediction head over a set of fixed embeddings generated from a fixed self-supervised base model. This task was analogous to linear probing. This head was trained for 100 epochs.

FIG. 15 shows the fixed embedding performance for various amounts of training data. Strong performance across the board was reported, superseding performance on a supervised-only version of the model. Furthermore, exceptional fixed embedding performance in the low-training data regime was observed. With training on just 1% of available data (approximately 7400 randomly selected spectra), a mean sMAPE of just over 4% across all properties was achieved, which approaches the performance of a supervised-only version of the LSM trained on the entire training dataset. Furthermore, the exceptional performance of the model in a fixed embedding paradigm suggests that the base pre-trained model was capturing a high level of semantic understanding of the MS2 domain. Additional fixed embedding results are displayed in FIGS. 15-19.

Unlike the gold-standard of spectral lookup, modified cosine similarity, which exhibits limited generalizability, it's demonstrated that this method was both robust and generalizable.

The property prediction performance on unseen molecules outperforms the state of the art for both the CASMI 2022 and Unknown datasets. Furthermore, the model exhibits strong performance in a fixed embedding paradigm, which suggests a strong base understanding of the MS/MS domain from pre-training.

Compared to gold-standards, MS2LSM also has significant benefits with regards to dataset size and therefore speed. It was shown that with a considerably smaller dataset, MS2LSM performs well on property prediction. This benefit was compounded by strong performance with fixed embeddings, demonstrating potential for MS2LSM to be a useful tool for generating machine-readable embeddings for downstream tasks. Not only do smaller datasets open up new application spaces, they also decrease the speed of training considerably. This increase of speed was compounded to the fact that modified cosine similarity is several orders of magnitude slower than MS2LSM, rendering it impractical at best for use in large scale MS2 experiments. Thus, as the field of metabolomics grows, there is a need for fast and accurate solutions (such as those described herein), which allow users to perform tasks such as property prediction and spectral lookup at a scale which matches the growth of the field. For example, MS2LSM is a good start to address these needs. The low data need of MS2LSM also opens up the possibility of fine tuning with experimentally tractable sample numbers, such as a well-curated library of isolated standards.

It is contemplated herein that the example MS2LSM may benefit from increased training of the self-supervised base in regards to both hyper-parameter tuning and pre-training dataset size.

For example, the pre-training dataset had roughly 110 million tokens, which is a fraction of the number of tokens used in other LLMs such as META's Llama series, trained on trillions of tokens [Touvron et al., 2023]. Even when compared to simple LLM precursors such as BeRT, which was trained on upwards of 3.3Bn words, the example MS2LSM still has a small dataset [Devlin et al., 2018]. Thus, performance improvements are anticipated as the training dataset is scaled.

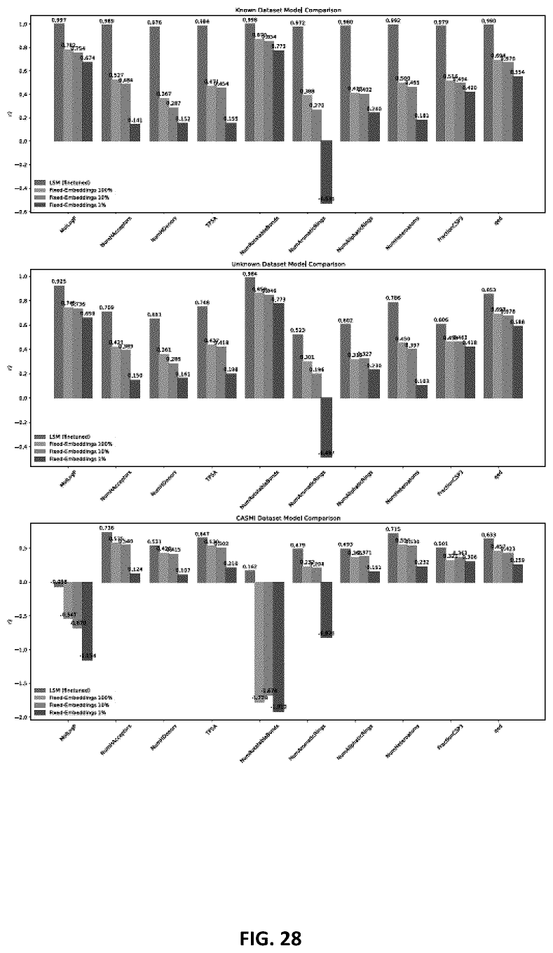

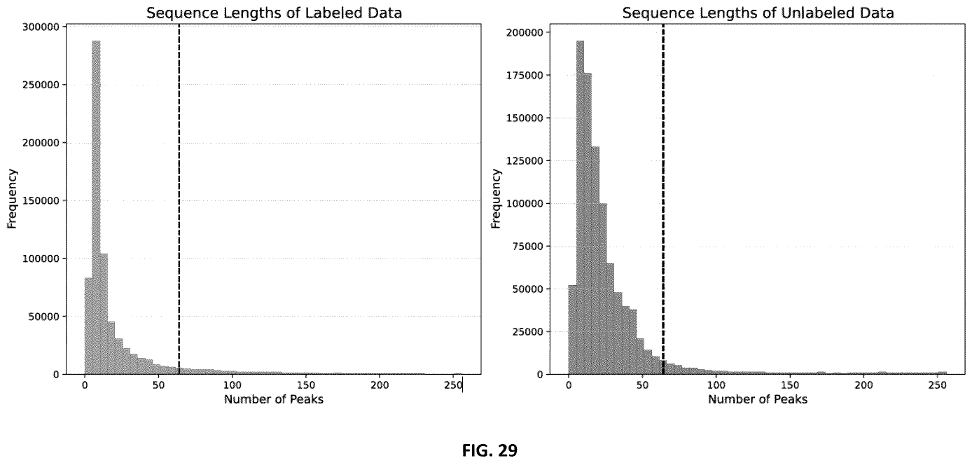

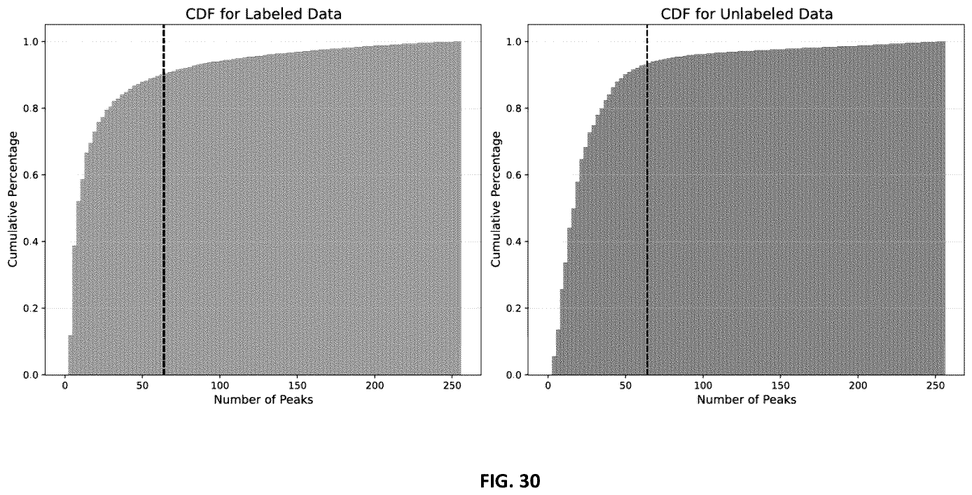

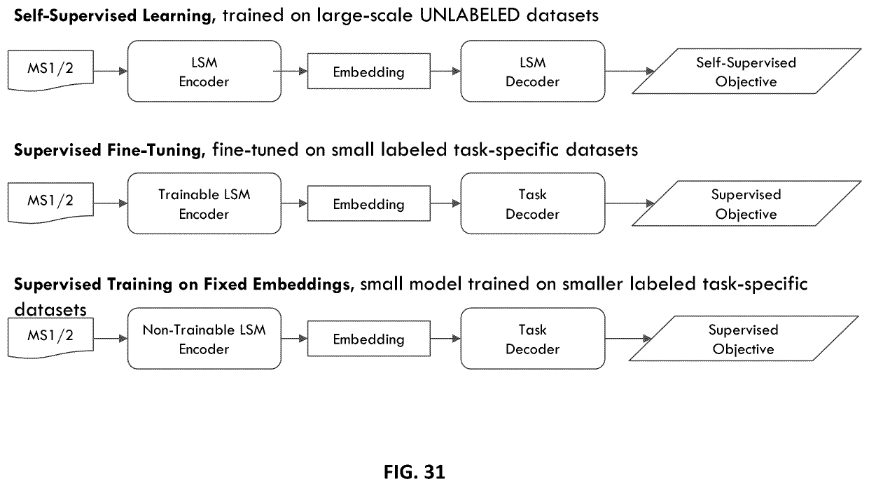

Furthermore, given the current dataset, it's believed that performance could be improved. Further hyper-parameter tuning can have significant effects on downstream performance, and this would yield improvements for all of the results. Increasing sequence length may also have favorable impacts on downstream performance. FIG. 29 and FIG. 30 show that roughly 90% of the fine-tuning data has a sequence length under 64.

Thus, training or fine-tuning with a longer sequence length could have favorable effects on performance and should be possible due to the use of alibi positional embeddings. However, additional training comes at a computational cost.

The example model also ignores important information about spectral acquisition which could improve performance when considered in alternate embodiments described herein. Notably, important information about ion mode, precursor adduct, charge state, or MS/MS collision energy isn't included in the example model, but could be included in an LSM. All four of these pieces of information have large impacts on the resultant MS/MS spectrum, so embodiments including these data should be substantially more performant. Finally, optimal strategies for peak embedding in Mass Spectrometry is an understudied subject. Embodiments using alternative spectrum embedding strategies such as those described in Huber et al. [2021a]; Voronov et al. [2022b] could potentially improve the results. Overall, the example MS2LSM showed that self-supervised pre-training was an effective technique in tandem Mass Spectrometry based deep-learning applications.

Fine-tuning a model pre-trained on MS/MS data yields superior results over baselines for spectral lookup and property prediction applications. Furthermore, supervised-only level results were achieved with a fraction of the training dataset size for downstream applications. The fixed embedding results also highlight the significant benefits of pre-training. Impressive performance in the challenging task of property prediction was demonstrated by training a straightforward model with fixed embeddings from the self-supervised base model on a modest dataset of approximately 7400 spectra. This success strongly indicates that, by utilizing embeddings from the example MS2LSM, further embodiments can effectively train high-performance models even in data-scarce scenarios common to the fields of metabolomics and proteomics.

Given the simplicity of the spectrum reconstruction method, it is believed that the output embeddings from the model are potentially sufficiently information-rich for some zero-shot capabilities. From a higher-level perspective, several applications of ML in Mass Spec can be greatly accelerated with pre-trained Mass-Spec foundation models. For example, just like molecule-level characteristics can be predicted from an MS/MS spectrum, sample level characteristics can be predicted from an MS spectrum.

Similarly to the reconstruction of hidden MS/MS peaks shown using the example model, one can reconstruct hidden MS1 peaks via a strong understanding of a sample's context. The ability to have both foundation models for the same data at different resolutions is a characteristic unique to Mass Spectrometry, which opens many doors for downstream tasks.

One such task is metabolic pathway discovery. Similarly to how Cui et al. [2023] use attention values to create gene-expression networks, an MS1 LSM could be used to find networks of strongly correlated peaks within an MS1 sample. Next, these peaks could be identified with MS2LSM. Then, this data could be used to construct a graph of related molecules. After incorporating longitudinal data into this graph, common molecular “highways” in this graph could be identified. Given that the nodes in this graph correspond to molecules, these highways show relationships between molecules over time, thus allowing for the discovery of metabolic pathways.

Another task that pre-trained models described herein may help with is de-novo molecular generation from MS/MS spectra Current state-of-the-art methods for this task often involve a spectral encoder, which is then used as context for an auto-regressive SMILES decoder, for example, as described in Butler et al. [2023]. It is believed that using a large pre-trained spectral encoder like the example MS2LSM as a base for this task could significantly improve method performance for such tasks. For example, generative tasks require a large amount of data, which usually does not exist in terms of labeled MS/MS spectra. Thus, given that it has been empirically shown that the example MS2LSM requires less data to get equivalent performance to baselines on downstream tasks, the pre-trained encoder could also help with this task.

Another important application of which could utilize models described herein (such as the example MS2LSM) is in helping eliminate the need for MS/MS altogether. Given a good LSM on MS1 data, the token-level MS1 LSM embeddings can be aligned to their respective MS2LSM embeddings. This can be done since peaks in MS1 encode molecules or large fragments, and these peaks can then be further isolated in MS/MS space, creating MS/MS spectra. Thus, if the MS2LSM output of the MS/MS spectra can be aligned with the encoding of the MS1 peaks, in some cases there may not be a need for MS/MS for molecular identification altogether. In this way, the example MS2LSM (and other models described herein) are envisioned to enable the growth of data independent acquisition workflows in metabolomics.

Strong results for spectral lookup and property prediction tasks have been shown with through the example method of implementing a large structural model as described herein, which is contemplated to be useful in improving any application involving mass spectrometry data.

### Additional Results on Property Prediction

TABLE 8
Evaluation Metrics Property Prediction across Datasets

| | | |
|---|---|---|
| Mean Unknown | Mean Known | Mean CASMI |

Modified Cosine

| | | | |
|---|---|---|---|
| R² | −0.186 | 0.922 | −.0257 |
| MAE | 5.70 | 1.400 | 7.519 |
| SMAPE | 0.141 | 0.013 | 0.193 |

MS2Prop Re-Implementation (Supervised)

| | | | |
|---|---|---|---|
| R² | 0.253 | 0.911 | 0.069 |
| MAE | 2.524 | 0.828 | 3.756 |
| SMAPE | 0.019 | 0.005 | 0.0285 |

MS2LSM (Supervised)

| | | | |
|---|---|---|---|
| R² | 0.173 | 0.791 | 0.045 |
| MAE | 3.666 | 2.152 | 4.804 |
| SMAPE | 0.038 | 0.026 | 0.046 |

MS2LSM (Fixed-Embedding)

| | | | |
|---|---|---|---|
| R² | 0.152 | 0.264 | −0.049 |
| MAE | 5.808 | 5.768 | 6.644 |
| SMAPE | 0.032 | 0.031 | 0.036 |

MS2LSM

| | | | |
|---|---|---|---|
| R² | 0.356 | 0.952 | 0.153 |
| MAE | 2.140 | 0.583 | 3.351 |
| SMAPE | 0.017 | 0.004 | 0.026 |

Table 8 contains property prediction results for LSM (fine-tuned), Cosine Similarity, MS2Prop, and LSM (supervised). LSM (supervised) is a supervised-only version of the LSM, trained With a slightly different embedding strategy to MS2Prop. FIG. 15 also reports fixed-embedding performance.

### Dataset Distribution

A key choice in the example model/method was choosing 64 as the sequence length, since this parameter has significant downstream impacts on model generalizability to novel applications. Additionally, this choice heavily impacts training speeds. Transformer-based models run time complexity is O(seq len\hat{ }2), so using the most optimal sequence length is important. For any spectra that had over 64 peaks, 64 of the first 192 peaks sorted from largest to smallest intensity were randomly selected FIG. 29 and FIG. 30 examine the number of peaks in the labeled dataset, as well as a randomly sampled subset of 6M peaks from the unlabeled dataset. A distribution of number of peaks, as well as their respective CDFs, is plotted. Thus, it is seen that about 90% and almost 95% of labeled training data falls within 64 peaks.

TABLE 9
Hyperparameters for self-supervised model

| Parameter | Selected value |
|---|---|
| max input peaks | 64 |
| learning rate | 1 × 10⁻⁶ |
| batch size | 448 |
| d model | 1024 |
| encoder layers | 16 |
| encoder attn heads | 16 |
| mask pct | 0.25 |
| alpha | 100.0 |
| beta | 1.0 |
| omega | 1.0 |

TABLE 10
Hyperparameters for property prediction model

| Parameter | Selected value |
|---|---|
| max input peaks | 64 |
| learning rate | 2.5 × 10⁻⁴ |
| batch size | 512 |
| d model | 1024 |
| encoder layers | 16 |
| encoder attn heads | 16 |
| num parameters | 202M |

TABLE 11
Hyperparameters for spectral lookup model.

| Parameter | Selected value |
|---|---|
| max input peaks | 64 |
| learning rate | 5 × 10⁻⁶ |
| batch size | 224 |
| d model | 1024 |
| encoder layers | 16 |
| encoder attn heads | 16 |
| out emb size | 512 |
| scheduler | OneCycleLR |
| num parameters | 202M |

TABLE 12
List of Molecular Properties used in example LSM
State Indexes

| | | | |
|---|---|---|---|
| MaxAbsEStateIndex | MaxEStateIndex | MinAbsEStateIndex | MinEStateIndex |

Physical Properties

| | | | |
|---|---|---|---|
| qed | MolWt | HeavyAtomMolWt | ExactMolWt |
| NumValenceElectrons | NumRadicalElectrons | MaxPartialCharge | MinPartialCharge |
| MaxAbsPartialCharge | MinAbsPartialCharge | MolLogP | MolMR |
| TPSA | FractionCSP3 | | |

Molecular Descriptors

| | | | |
|---|---|---|---|
| FpDensityMorgan1 | FpDensityMorgan2 | FpDensityMorgan3 | BCUT2D_MWHI |
| BCUT2D_MWLOW | BCUT2D_CHGHI | BCUT2D_CHGLO | BCUT2D_LOGPHI |
| BCUT2D_LOGPLOW | BCUT2D_MRHI | BCUT2D_MRLOW | AvgIpc |
| BalabanJ | BertzCT | Chi0 | Chi0n |
| Chi0v | Chi1 | Chi1n | Chi1v |
| Chi2n | Chi2v | Chi3n | Chi3v |
| Chi4n | Chi4v | HallKierAlpha | Ipc |
| Kappa1 | Kappa2 | Kappa3 | LabuteASA |

VSA Properties

| PEOE_VSA1 | PEOE_VSA10 | PEOE_VSA11 | PEOE_VSA12 |
|---|---|---|---|
| PEOE_VSA13 | PEOE_VSA14 | PEOE_VSA2 | PEOE_VSA3 |
| PEOE_VSA4 | PEOE_VSA5 | PEOE_VSA6 | PEOE_VSA7 |
| PEOE_VSA8 | PEOE_VSA9 | SMR_VSA1 | SMR_VSA10 |
| SMR_VSA2 | SMR_VSA3 | SMR_VSA4 | SMR_VSA5 |
| SMR_VSA6 | SMR_VSA7 | SMR_VSA8 | SMR_VSA9 |
| SlogP_VSA1 | SlogP_VSA10 | SlogP_VSA11 | SlogP_VSA12 |
| SlogP_VSA2 | SlogP_VSA3 | SlogP_VSA4 | SlogP_VSA5 |
| SlogP_VSA6 | SlogP_VSA7 | SlogP_VSA8 | SlogP_VSA9 |
| EState VSA Properties | | | |
| EState_VSA1 | EState_VSA10 | EState_VSA11 | EState_VSA2 |
| EState_VSA3 | EState_VSA4 | EState_VSA5 | EState_VSA6 |
| EState_VSA7 | EState_VSA8 | EState_VSA9 | VSA_EState1 |
| VSA_EState10 | VSA_EState2 | VSA_EState3 | VSA_EState4 |
| VSA_EState5 | VSA_EState6 | VSA_EState7 | VSA_EState8 |
| VSA_EState9 | | | |

Structural Properties

| | | | |
|---|---|---|---|
| HeavyAtomCount | NHOHCount | NOCount | NumAliphaticCarbocycles |
| NumAliphaticHeterocycles | NumAliphaticRings | NumAromaticCarbocycles | NumAromaticHeterocycles |
| NumAromaticRings | NumHAcceptors | NumHDonors | NumHeteroatoms |
| NumRotatableBonds | NumSaturatedCarbocycles | NumSaturatedHeterocycles | NumSaturatedRings |
| RingCount | | | |

Functional Group Properties

| | | | |
|---|---|---|---|
| fr_Al_COO | fr_Al_OH | fr_Al_OH_noTert | fr_ArN |
| fr_Ar_COO | fr_Ar_N | fr_Ar_NH | fr_Ar_OH |
| fr_COO | fr_COO2 | fr_C_O | fr_C_O_noCOO |
| fr_C_S | fr_HOCCN | fr_Imine | fr_NH0 |
| fr_NH1 | fr_NH2 | fr_N_O | fr_Ndealkylation1 |
| fr_Ndealkylation2 | fr_Nhpyrrole | fr_SH | fr_aldehyde |
| fr_alkyl_carbamate | fr_alkyl_halide | fr_allylic_oxid | fr_amide |
| fr_amidine | fr_aniline | fr_aryl_methyl | fr_azide |
| fr_azo | fr_barbitur | fr_benzene | fr_benzodiazepine |
| fr_bicyclic | fr_diazo | fr_dihydropyridine | fr_epoxide |
| fr_ester | fr_ether | fr_furan | fr_guanido |
| fr_halogen | fr_hdrzine | fr_hdrzone | fr_imidazole |
| fr_imide | fr_isocyan | fr_isothiocyan | fr_ketone |
| fr_ketone_Topliss | fr_lactam | fr_lactone | fr_methoxy |
| fr_morpholine | fr_nitrile | fr_nitro | fr_nitro_arom |
| fr_nitro_arom_nonortho | fr_nitroso | fr_oxazole | fr_oxime |
| fr_para_hydroxylation | fr_phenol | fr_phenol | fr_phos_acid |
| fr_phos_ester | fr_piperdine | fr_piperzine | fr_tetrazole |
| fr_term_acetylene | fr_priamide | fr_thiazole | fr_urea |
| fr_sulfide | fr_sulfone | fr_pyridine | fr_thiocyan |
| fr_thiophene | fr_quatN | fr_sulfonamd | fr_prisulfonamd |
| fr_unbrch_alkane | | | |

### Example 8: Generative De Novo Molecular Structure, Sub-Structures and Identification

A significant challenge in the annotation of mass spectral data is that many molecular structures encountered in complex mixtures, such as biological samples, are novel and thus not present in common (or any) databases. It is not uncommon in practice for fewer than 1000 or even 20% of the acquired MS2 spectra from a sample to be annotated through conventional molecular identification processes, such as by spectral database lookup [da Silva, R. R., Dorrestein, P. C. & Quinn, R. A. Illuminating the dark matter in metabolomics. Proceedings of the National Academy of Sciences of the United States of America vol. 112 12549-12550 (2015)]. To address this challenge, an autoregressive generative model was trained to accept MS2 spectra as input and generatively output candidate molecular structures compatible with the acquired spectra, and thus a powerful new approach to annotating spectra of novel molecules and molecules that do not appear in any given reference database.

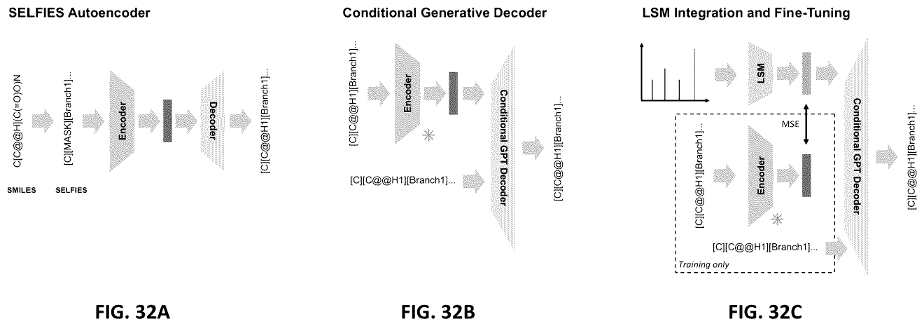

A large spectral model (LSM) comprising an MS2 modality was pre-trained according to methods described herein similar to those illustrated in Examples 1-7. The resulting LSM was then adapted to perform de novo molecular generation following the approach outlined in FIGS. 32A-C. Molecular structure was encoded by converting SMILES to SELFIES, using SELFIES tokens as the vocabulary for subsequent models. A BERT-style encoder-decoder model was trained to predict masked SELFIES tokens, FIG. 32A. With the fixed BERT encoder, a conditional GPT-2 decoder was trained to generate initial predictions based on context embeddings from the BERT encoder in an autoregressive manner, FIG. 32B. Next, the LSM embeddings and the BERT encoder embeddings were fed to the pre-trained GPT-2 decoder as context embeddings, FIG. 32C.

The BERT and conditional GPT models were trained on a subset of 100M molecules from a common reference database [Irwin, J. J. et al. ZINC20-A Free Ultralarge-Scale Chemical Database for Ligand Discovery. J. Chem. Inf Model. 60, 6065-6073 (2020)]. This architecture and training resulted in a model to predict de novo molecular identities from the LSM spectral embeddings during inference.

The decoder was structured to generate multiple distinct molecules for a single input LSM embedding and developed to output any requested number of generative predictions as candidate structures. In certain implementations, a single generative structure was generated. In other implementations, the number of generative molecular generations was five or fewer, 10 or fewer, 100 or fewer, or 1000 or fewer. A heuristic re-ranker was employed for evaluating performance at different numbers of generations. The reranking of generated molecules was achieved by minimizing the absolute difference between the mass of the generated molecule Mg and the precursor's mass with adduct adjustments I!.M_{adduct}. For a given adduct, the equation for the mass difference is as follows: I!.M=min_{adducts}IM₉−(Mₚ+I!.M_{adduct})I, where Mₚ is the precursor mass from the mass spectrometry data and I!.M_{adduct} is the mass adjustment for a specific adduct, which may involve addition or subtraction of the adduct's mass. The possible adducts are: [M]⁺, [M+H]⁺, [M+Na]⁺, [M+K]⁺, [M+NH4]⁺, [M+2H]²⁺, [M+H+Na]²⁺, [M+2Na]²⁺, [M−H]⁻, [M+Cl]⁻, [M+FA]⁻,[M+Br]⁻. The generated molecule with the smallest 1!.M was considered the best match to the precursor ion.

### Test Datasets for Model Evaluation

The generative model was tested using different test datasets of unknown molecules, both for in and out-of-distribution settings. For the in-distribution evaluation, the de novo molecular generation model was used to identify molecules spectrally distinct from any molecule used in training. For the out-of-distribution evaluation, spectra from the published CASMI 2017 and 2022 datasets were employed.

100 SMILES representations were generated for spectra and rank them based on precursor mass. We consider the top 1, top 10, and top 100 candidates. 100 structure generations were performed for every structure in the CASMI 2017, CASMI 2022. The quality of the generations was measured by calculating the maximum Tanimoto score achieved in each output group with respect to the ground truth query. For in-distribution data, a mean maximum Tanimoto score of 0.63 for the top 100 predictions and 0.48 for the top 1 prediction was achieved. Tanimoto score of greater than 0.5 is generally considered useful.

### Substructure Prediction

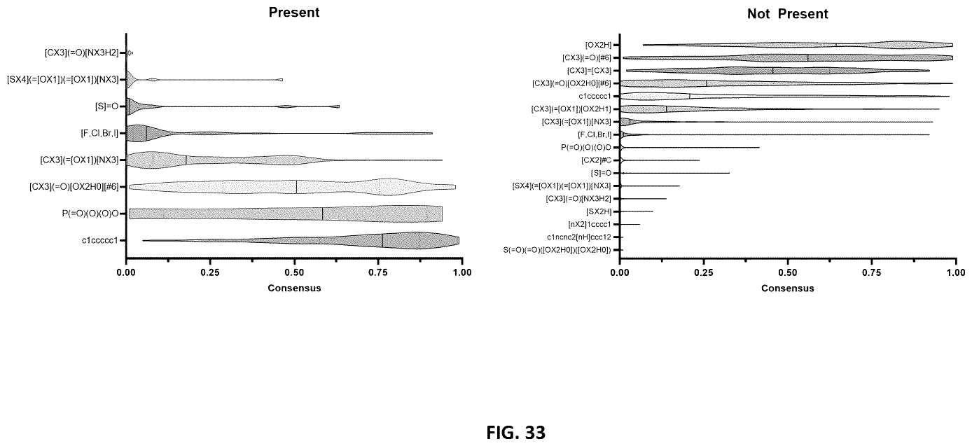

Intuitive pictures of the generated structures were obtained by querying against molecular substructures using a list of 18 common drug discovery motifs. Substructures were then used to perform consensus scoring to evaluate the reliability of structural predictions. The consensus score for a given substructure was defined as the fraction of generated predictions that include the substructure, providing a normalized measure from 0 (no consensus) to 1 (unanimous agreement). A high consensus score indicated a high probability that the given substructure was present in the actual molecular identity, as shown in FIG. 33.

### REFERENCES

1. Oihane E Alboniga, Joaquin Cubiella, Luis Bujanda, Maria Encarnacion Blanco, Borja Lanza, Cristina Alonso, Beatriz Nafrna, and Juan Manuel Falcon-Perez A novel approach on the use of samples from faecal occult blood screening kits for metabolomics analysis: Application in colorectal cancer population. Metabolites, 13(3):321, 2023.
2. Tom Brown, Benjamin Mann, Nick Ryder, Melanie Subbiah, Jared D Kaplan, Prafulla Dhariwal, Arvind Neelakantan, Pranav Shyam, Girish Sastry, Amanda Askell, et al.

Language models are few-shot learners. Advances in neural information processing systems, 33:1877-1901, 2020.
3. Thomas Butler, Abraham Frandsen, Rose Lightheart, Brian Bargh, James Taylor, TJ Bollerman, Thomas Kerby, Kiana West, Gennady Voronov, Kevin Moon, et al. Ms2 mol: A transformer model for illuminating dark chemical space from mass spectra. 2023.
4. Haotian Cui, Chloe Wang, Hassaan Maan, Kuan Pang, Fengning Luo, and Bo Wang, scgpt: Towards building a foundation model for single-cell multi-omics using generative ai. bioRxiv, pages 2023-04, 2023.
5. Ricardo R da Silva, Pieter C Dorrestein, and Robert A Quinn. Illuminating the dark matter in metabolomics. Proceedings of the National Academy of Sciences, 112(41):12549-12550, 2015.
6. Jacob Devlin, Ming-Wei Chang, Kenton Lee, and Kristina Toutanova Bert: Pre-training of deep bidirectional transformers for language understanding, arXiv preprint arXiv:1810.04805, 2018.
7. Alexey Dosovitskiy, Lucas Beyer, Alexander Kolesnikov, Dirk Weissenborn, Xiaohua Zhai, Thomas Unterthiner, Mostafa Dehghani, Matthias Minderer, Georg Heigold, Sylvain Gelly, et al. An image is worth 16×16 words: Transformers for image recognition at scale. arXiv preprint arXiv:2010.11929, 2020.
8. Ana Filipa Fernandes, Luis Gafeira Goncalves, Maria Bento, Sandra I Anjo, Bruno Manadas, Clara Barroso, Miguel Villar, Rita Macedo, Maria Joao Simoes, and Ana Varela Coelho. Mass spectrometry-based proteomic and metabolomic profiling of serum samples for discovery and validation of tuberculosis diagnostic biomarker signature. International Journal of Molecular Sciences, 23(22):13733, 2022.
9. Samuel Goldman, Jeremy Wohlwend, Martin Strazar, Guy Haroush, Ramnik J Xavier, and Connor W Coley. Annotating metabolite mass spectra with domain-inspired chemical formula transformers. Nature Machine Intelligence, pages 1-15, 2023.
10. Hao Guo, Kebing Xue, Haiming Sun, Weihao Jiang and Shiliang Pu Contrastive learning-based embedder for the representation of tandem mass spectra. Analytical Chemistry, 2023.
11. Kaiming He, Xinlei Chen, Saining Xie, Yanghao Li, Piotr Doll'ar, and Ross Girshick Masked autoencoders are scalable vision learners. In Proceedings of the IEEE/CVF conference on computer vision and pattern recognition, pages 16000-16009, 2022.
12. Florian Huber, Lars Ridder, Stefan Verhoeven, Jurriaan H Spaaks, Faruk Diblen, Simon Rogers, and Justin J J Van Der Hooft. Spec2vec: Improved mass spectral similarity scoring through learning of structural relationships. PLoS computational biology, 17(2):e1008724, 2021a.
13. Florian Huber, Sven van der Burg Justin J J van der Hooft, and Lars Ridder. Ms2deepscore: a novel deep learning similarity measure to compare tandem mass spectra. Journal of cheminformatics, 13(1):84, 2021b.
14. John Jumper, Richard Evans, Alexander Pritzel, Tim Green, Michael Figurnov, Olaf Ronneberger, Kathiyn Tunyasuvunakool, Russ Bates, Augustin Zidek, Anna Potapenko, et al. Highly accurate protein structure prediction with alphafold Nature, 596(7873):583-589, 2021.
15. Yuan Liu, Hua Zhang, William F Dove, Zicong Wang, Zhijun Zhu, Perry J Pickhardt, Mark Reichelderfer, and Lingjun Li. Quantification of serum metabolites in early colorectal adenomas using isobaric labeling mass spectrometry. Journal of proteome research, 22(5): 1483-1491, 2023.
16. Oana C Marian, Jonathan D Teo, Jun Yup Lee, Huitong Song, John B Kwok, Ramon Landin-Romero, Glenda Halliday, and Anthony S Don. Disrupted myelin lipid metabolism differentiates frontotemporal dementia caused by grn and c9orf72 gene mutations. Acta neuropathologica communications, 11(1):52, 2023.
17. Sean D Meehan, Mengming Hu, Matthew B Veldman, and Sanjoy K Bhattacharya Metabolomics dataset of zebrafish optic nerve regeneration after injury. Data in brief, 48:109102, 2023.
18. S S Mehta. Massbank of north America (mona): An open-access, auto-curating mass spectral database for compound identification in metabolomics presentation, 2020.
19. Cecilia Noecker, Juan Sanchez, Jordan E Bisanz, Veronica Escalante, Margaret Alexander, Kai Trepka, Almut Heinken, Yuanyuan Liu, Dylan Dodd, Ines Thiele, et al.

Systems biology illuminates alternative metabolic niches in the human gut microbiome. bioRxiv, pages 2022-09, 2022.
20. Mathilde Pruvost, Julia Patzig, Camila Yattah, Ipek Selcen, Marylens Hernandez, Hye-Jin Park, Sarah Moyon, Shibo Liu, Malia S Morioka, Lindsay Shopland, et al. The stability of the myelinating oligodendrocyte transcriptome is regulated by the nuclear lamina. Cell Reports, 42(8), 2023.
21. Robin Roychaudhuri, Hasti Atashi, and Solomon H Snyder. Serine racemase mediates subventricular zone neurogenesis via fatty acid metabolism. Stem Cell Reports, 2023.
22. Amnah Siddiqa, Yating Wang, Maheshwor Thapa, Dominique E Martin, Andreia N Cadar, Jenna M Bartley, and Shuzhao Li. A pilot metabolomic study of drug interaction with the immune response to seasonal influenza vaccination. npj Vaccines, 8(1):92, 2023.
23. Hugo Touvron, Louis Martin, Kevin Stone, Peter Albert, Amjad Almahairi, Yasmine Babaei, Nikolay Bashlykov, Soumya Batra, Prajjwal Bhargava, Shruti Bhosale, et al. Llama 2: Open foundation and fine-tuned chat models. arXiv preprint arXiv:2307.09288, 2023.
24. Hiroshi Tsugawa, Kazutaka Ikeda, Mikiko Takahashi, Aya Satoh, Yoshifumi Mori, Haruki Uchino, Nobuyuki Okahashi, Yutaka Yamada, Ipputa Tada, Paolo Bonini, et al. A lipidome atlas in ms-dial 4. Nature biotechnology, 38(10):1159-1163, 2020.
25. Ashish Vaswani, Noam Shazeer, Niki Parmar, Jakob Uszkoreit, Llion Jones, Aidan N Gomez, Lukasz Kaiser, and Illia Polosukhin. Attention is all you need. Advances in neural information processing systems, 30, 2017.
26. Gennady Voronov, Abe Frandsen, Brian Bargh, David Healey, Rose Lightheart, Tobias Kind, Pieter Dorrestein, Viswa Colluru, and Thomas Butler. Ms2prop: A machine learning model that directly predicts chemical properties from mass spectrometry data for novel compounds. bioRxiv, pages 2022-10, 2022a.
27. Gennady Voronov, Rose Lightheart, Joe Davison, Christoph A Krettler, David Healey, and Thomas Butler. Multi-scale sinusoidal embeddings enable learning on high resolution mass spectrometry data. arXiv preprint arXiv:2207.02980, 2022b.
28. Mingxun Wang, Jeremy J Carver, Vanessa V Phelan, Laura M Sanchez, Neha Garg, Yao Peng, Don Duy Nguyen, Jeramie Watrous, Clifford A Kapono, Tal Luzzatto-Knaan, et al.

Sharing and community curation of mass spectrometry data with global natural products social molecular networking. Nature biotechnology, 34(8):828-837, 2016.
29. Jeramie Watrous, Patrick Roach, Theodore Alexandrov, Brandi S Heath, Jane Y Yang, Roland D Kersten, Menno van der Voort, Kit Pogliano, Harald Gross, Jos M Raaijmakers, et al. Mass spectral molecular networking of living microbial colonies. Proceedings of the National Academy of Sciences, 109(26):E1743-E1752, 2012.
30. Wenchao Wei, Chi Chun Wong Zhongjun Jia, Weixin Liu, Changan Liu, Fenfen Ji, Yasi Pan, Feixue Wang Guoping Wang Liuyang Zhao, et al. Parabacteroides distasonis uses dietary inulin to suppress nash via its metabolite pentadecanoic acid. Nature Microbiology, 8(8):1534-1548, 2023.
31. Zhenda Xie, Zheng Zhang Yue Cao, Yutong Lin, Jianmin Bao, Zhuliang Yao, Qi Dai, and Han Hu. Simmim: A simple framework for masked image modeling. In Proceedings of the IEEE/CVF Conference on Computer Vision and Pattern Recognition, pages 9653-9663, 2022.

While several embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. A method of analyzing a sample, the method comprising:
introducing the sample to an inlet of a mass spectrometer;
ionizing at least a portion of the sample;
obtaining one or more raw mass spectra of the ionized portion of the sample using a mass spectrometer;
processing the raw mass spectra of the ionized portion of the sample using a large spectral model having a data utilization rate of at least 2%, wherein m/z values of the one or more raw mass spectra are not binned during or prior to the processing, to generate at least one predictive classifier associated with the sample; and
outputting the at least one predictive classifier associated with the sample.
